(19) United States
(12) Patent Application Publication
(10) Pub. No.: US 2025/0277321 A1
(43) Pub. Date: Sep. 4, 2025

(54) SELECTIVE ELECTROCHEMICAL CAPTURE AND RELEASE OF LITHIUM FROM SEAWATER

(71) Applicant: The Regents of the University of California, Oakland, CA (US)

(72) Inventors: Gabriel Ménard, Goleta, CA (US); Lior Sepunaru, Goleta, CA (US); Zongheng Wang, Santa Barbara, CA (US); Shannon Heinrich, Goleta, CA (US)

(73) Assignee: The Regents of the University of California, Oakland, CA (US)

(21) Appl. No.: 18/858,527

(22) PCT Filed: Apr. 21, 2023
(86) PCT No.: PCT/US23/19388

§ 371 Date: Oct. 21, 2024

Related U.S. Application Data
(60) Provisional application No. 63/333,278, filed on Apr. 21, 2022.

(51) Int. Cl. C25C 1/02; C02F 1/461; C02F 101/10; C02F 103/06; C02F 103/08; C07F 5/02; C25C 7/02

(52) U.S. Cl. CPC C25C 1/02; C02F 1/46109; C07F 5/027; C25C 7/02; C02F 2001/46133; C02F 2101/10; C02F 2103/06; C02F 2103/08; C02F 2201/4613

(57) ABSTRACT

Carborane compositions useful for capturing lithium are disclosed. Method and systems for electrochemically controlling the compositions to capture and release the lithium are also disclosed.

### CROSS REFERENCE TO RELATED APPLICATIONS

This application claims the benefit under 35 U.S.C. Section 119(e) of U.S. Provisional Application No. 63/333,278, filed Apr. 21, 2022, by Gabriel Menard, Lior Sepunaru, Zongheng Wang, and Shannon Heinrich, entitled “SELECTIVE ELECTROCHEMICAL CAPTURE AND RELEASE OF LITHIUM FROM SEAWATER.” which application is incorporated by reference herein.

### BACKGROUND OF THE INVENTION

### 1. Field of the Invention

The present disclosure relates to methods and systems for capturing and releasing Lithium from seawater.

### 2. Description of the Related Art

[The present disclosure refers to a number of references in superscripts which are listed in the reference section at the end of the specification.]

Lithium is a critical element which is experiencing a skyrocketing demand due to the rapid deployment of Li-ion batteries for energy storage applications. Current Li⁺ extraction relies on Li-rich ore mining or on the lime-soda solar evaporation technique from Li-rich brines, especially from the “Lithium Triangle” centered around Chile, Bolivia, and Argentina; however, this latter process is very slow (1-2 years). Moreover, with surging demand for Li, it is expected that current production (120 kt/year) will very soon not meet projected market demands (up to 900 kt/yr by 2025). It is estimated that seawater contains about 10,000 more dissolved Li than all terrestrial and freshwater reserves. While many sorbent-based membrane technologies are being explored for the selective capture of Li from seawater or from salty brine well waters, such as in Direct Lithium Extraction (DLE), these methods typically rely on further treatment of the membranes with strong acids to remove the extracted Li. They usually require a large amount and many cost-increasing active materials, such as specific molecules and life-limited absorbents, cannot work well for seawater Li ion concentration which is very low among many concentrated salts. What is needed are improved methods of extracting lithium from lithium containing solutions. The present invention satisfies this need.

### SUMMARY OF THE INVENTION

The present disclosure describes compositions of matter useful extracting Li from a lithium containing fluid, such as seawater. The present disclosure further describes a system and method capturing and releasing the lithium using the composition of matter and an electrochemical approach requiring only the application of an electrical current to control the capture and release of Li. In various embodiments, this technology may circumvent the need for expensive membranes, acidic workups, and overcome related environmental concerns.

### BRIEF DESCRIPTION OF THE DRAWINGS

Referring now to the drawings in which like reference numbers represent corresponding parts throughout

FIG. 1. Capture and release of Li⁺ using carboranes (Cb) with selective donors (L).

FIG. 2. Size-selective coordination strategy.

FIG. 3a. Li⁺-selective macrocycle groups (L) on carborane and heterogeneous electrochemical capture/release using these electrode-tethered selective carboranes; and anchoring techniques on Au (FIG. 3b); and Carbon (C) (FIG. 3c).

FIG. 4a-4f Synthesis pathways for different carborane compounds, wherein FIG. 4a shows the synthesis of mono-Cb 14-crown-4, FIG. 4b shows the synthetic pathway to carborane phosphine oxide crown, FIG. 4c shows more examples of carborane crown with different crown sizes and bridge atoms, FIG. 4d shows synthesis of Di-Cb 14-crown-4, FIG. 4e shows synthesis of Cb 16-crown-4 and FIG. 4f shows synthesis of Cb 18-crown-6.

FIG. 5a. Chemical reduction of mono-carborane 14-crown-4 (1) to its nido-form (1-nido). Solid-state molecular structure, obtained by XRD studies, is also shown.

FIG. 5b. Reduction of bis-carborane 14-crown-4 (2) to its nido- form (2-nido).

FIG. 6a. ⁷Li NMR spectra of LiTFAB with different equivalents of 1 at room temperature; FIG. 6b ⁷Li NMR spectra of LiTFAB and with 1 equivalent of regular 12-crown-4, 1 and 0 equivalent of carborane crown 1 at room temperature. Procedure for lithium binding affinity studies with 1 to obtain data in FIG. 6: In a sealed J. Young NMR tube, a 0.006 M LiTFAB solution was mixed with different equivalents of 1 in MeCN-d₃. A scaled capillary tube containing LiCl in D₂O was then inserted into the NMR tube to serve as an external standard. ¹H, ¹¹B, ¹⁹F and ⁷Li NMR spectra were taken using different equivalents of 1 at 25° C.

FIG. 7a. ⁷Li NMR spectra of 2 with different equivalents of LiTFAB at room temperature; FIG. 7b shows ⁷Li NMR spectra of 2-nido with different equivalents of LiTFAB at room temperature; FIG. 7c shows ⁷Li and ²³Na NMR spectra of 2-nido with 2.5 equivalent of LiTFAB, NaTFAB and KTFAB at room temperature. General procedure for lithium capture studies in FIG. 7 and FIG. 8: In an NMR tube, the carboranes were mixed with different equivalents of LiTFAB in MeCN-di. A sealed capillary tube containing LiTFAB in MeCN-d₃ was then inserted into the NMR tube to serve as an external standard. ¹H, ¹¹B, ¹⁹F and ⁷Li NMR spectra were taken using different equivalents of LiTFAB at 25° C. General procedure for selectivity studies in FIG. 7 and FIG. 8: In an NMR tube, the carboranes were mixed with 1 equivalent each of LiTFAB. NaTFAB and KTFAB in MeCN-d₃. A sealed capillary containing LiTFAB, NaTFAB and KTFAB in MeCN-d₃ was then inserted into the NMR tube to serve as an external standard. ¹H, ¹¹B, ¹⁹F, ⁷Li and ²³Na NMR spectra were taken at 25, 5, −10, −25 and −38.5° C.

FIG. 8a. ⁷Li NMR spectra of 1 with different equivalents of LiTFAB at room temperature. FIG. 8b ⁷Li and ²³Na NMR spectra of 1 with 1 equivalent each of LiTFAB, NaTFAB and KTFAB at variable temperatures. FIG. 8c ⁷Li NMR spectra of 1-nido with different equivalents of LiTFAB at room temperature.

FIG. 9a. ¹¹B NMR spectra of 1-nido with LiTFAB, LiCl and LiPF₆ at room temperature. FIG. 9b Cyclic voltammetry of 1 with addition of LiPF₆ at a 100 mV/s scan rate. Procedure for lithium binding affinity studies with 1-nido in FIG. 9 and FIG. 10: In a J. Young NMR tube, a 0.006 M LiPF₆ solution was mixed with different equivalents of 1-nido in MeCN-d₃. A sealed capillary tube containing LiTFAB in MeCN-d₃ was then inserted into the NMR tube to serve as an external standard. ¹H, ¹¹B, ¹⁹F and ⁷Li NMR spectra were taken using different equivalents of 1-nido at 25° C. and −38.5° C.

FIG. 10a. ⁷Li NMR spectra of LiPF₆ with different equivalents of 1-nido at room temperature; FIG. 10b shows ⁷Li NMR spectra of LiPF₆ with 1 equivalent of 1-nido at −38.5° C. and room temperature.

FIG. 11a shows ⁷Li and ²³Na NMR spectra of LiPF₆ and NaPF₆ with 1 equivalent of synthesized 14-crown-4 and 18-crown-6 at room temperature; FIG. 11b shows ⁷Li and ²³Na NMR spectra of LiTFAB and with different equivalent of 1-nido at room temperature. Procedure for lithium selectivity studies with 1-nido in FIG. 11: In a J. Young NMR tube, 0.006 M solutions of LiPF₆ and of NaPF₆ were mixed together with different equivalents of 1-nido in MeCN-ds. A sealed capillary tube containing LiTFAB and NaTFAB in MeCN-d₃ was then inserted into the NMR tube to serve as an external standard. ¹H, ¹¹B, ¹⁹F, ⁷Li and ²³Na NMR spectra were taken using different equivalents of 1-nido at 25° C.

FIG. 12a shows ⁷Li NMR spectra of LiPF₆ with an aliquot of DMF followed by 12-crown-4 in MeCN-d₃. FIG. 12b shows Unlocked ⁷Li NMR spectra of LiPF₆ with different equivalents of 1-nido in DMF at room temperature, followed by addition of FcPF₆ (LiTFAB peak ignored for clarity); FIG. 12c shows ¹¹B NMR spectra of the LiPF₆ reaction with 1-nido before and after FcPF₆.

FIG. 13. Possible substitution on carborane cage.

FIG. 14. (left) Crown ether as ligand on Cb cage; (right) Cb 14-crown-4.

FIG. 15. (left) Other macrocycle ligands; (middle, right) azo 9-crown-3 Cb carborane with and without formal positive charge group.

FIG. 16. (left) Spacer groups between Cb and crown; (right) azo 9-crown-3 Cb carborane with P═O spacer and a formal positive charge group.

FIG. 17 (left) carborane crown with methyl functionalized cage; (right) Carborane crown with vinyl functionalized cage for anchoring.

FIGS. 18-19 illustrate examples of two (bis) Cb cage compounds.

FIG. 20 illustrate examples of carborane with acyclic ether ligands.

FIG. 21. Flowchart illustrating a method of making a composition of matter and apparatus according to one or more embodiments.

FIG. 22. Flowchart illustrating a method of capturing and releasing lithium (e.g., lithium ions).

### DETAILED DESCRIPTION OF THE INVENTION

In the following description of the preferred embodiment, reference is made to the accompanying drawings which form a part hereof, and in which is shown by way of illustration a specific embodiment in which the invention may be practiced. It is to be understood that other embodiments may be utilized and structural changes may be made without departing from the scope of the present invention.

### Technical Description

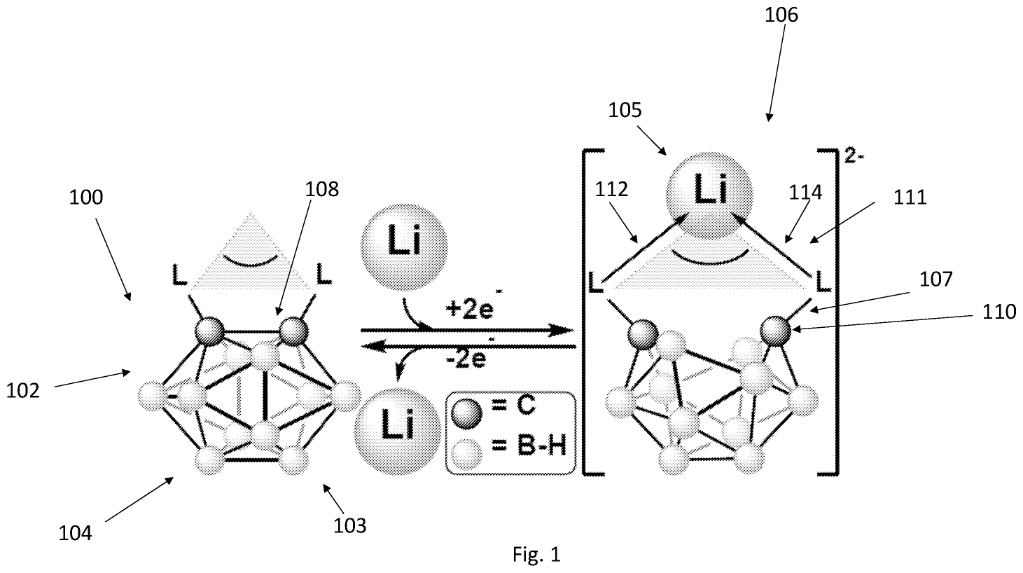

The present disclosure describes methods, systems and compositions using carborane (Cb) molecules for the capture and release of Li⁺ from lithium containing solvents and fluids (including, but not limited to, seawater). FIG. 1 illustrates an example using the redox-switchable chelating properties of ortho-Cb containing Li⁺-selective macrocyclic donors (L) for enabling targeted capture of the Li⁺.

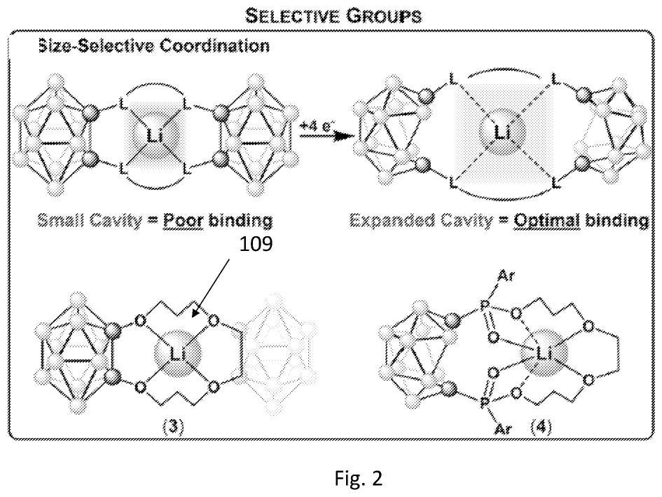

Studies have shown that 14-crown-4 and related crowns are highly selective for Li⁺ binding versus other alkali metals.¹¹ However, due to the exceptional binding affinity of crown ethers for Li⁺, it can be challenging to remove Li⁺ from traditional crowns once bound. Redox-active Cb crown molecules according to examples described herein contain a crown binding sphere that can be modulated electrochemically by switching from the closo to the nido Cb states. Reduction of closo-Cb to the nido-Cb results in rupture of the C—C bond resulting in cage opening and an increased crown bite angle¹⁵. This redox-switchable binding motif allows for two possible binding pathways: 1) strong binding in the nido form, but poor binding in the closo form (as shown in FIG. 2) or; 2) the opposite, with strong binding in the closo form, but weak binding in the opened nido form (not shown).

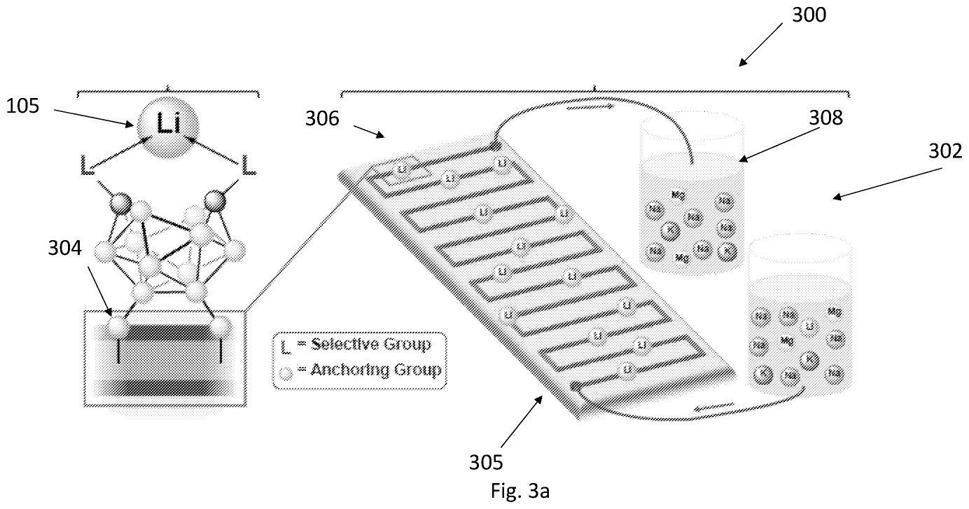

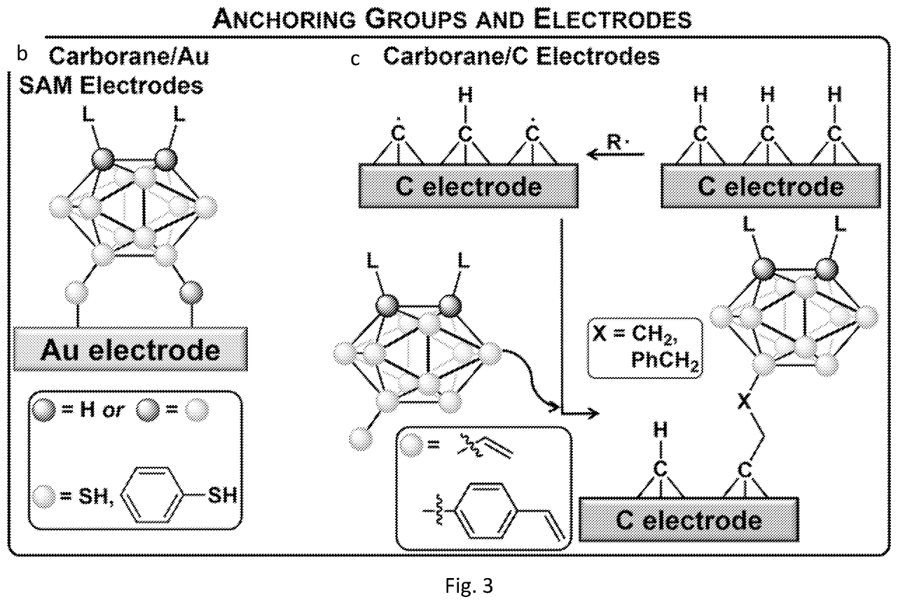

FIG. 3 illustrates how anchoring these selective Cbs to electrode surfaces allows for the heterogenous capture and release of Li⁺ from seawater under flow conditions. Example electrodes include, but are not limited to, Cb-functionalized flow-field electrodes or high-porosity electrodes. FIG. 3 illustrates how Cb-functionalized electrodes can be prepared via: surface assembled monolayers (SAMs) on gold (FIG. 3b), or; covalent surface grafting on carbon (FIG. 3c). The use of selective Cb-adhered flow fields allows for continuous, capture of Li⁺ from lithium containing fluids such as seawater, which is economically advantageous for Li⁺ extraction as compared to existing methods.

However, the carborane compounds can be implemented in a variety of capturing systems. In another example, Li⁺ can be captured in a biphasic system using immiscible organic solvents, by extracting the Li⁺ into the organic phase in the solvent and then separating it from the solvent (e.g., seawater) via bulk electrolysis (switching the Cb crown from nido to closo or vice versa for reduced coordination). Once coordination towards Li is switched off (via a change in the crown-ether size), Li⁺ can preferentially diffuse back into a fresh aqueous phase.

### Example Synthesis Pathways

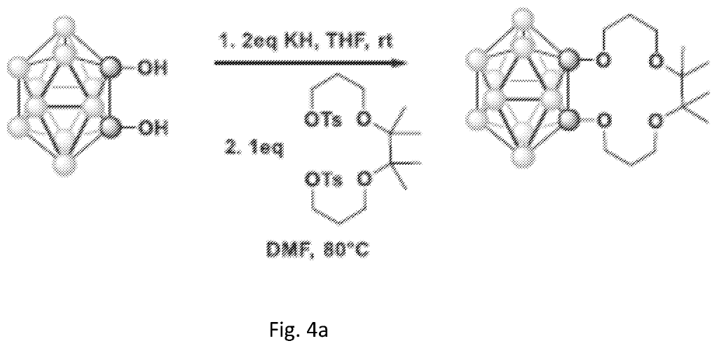

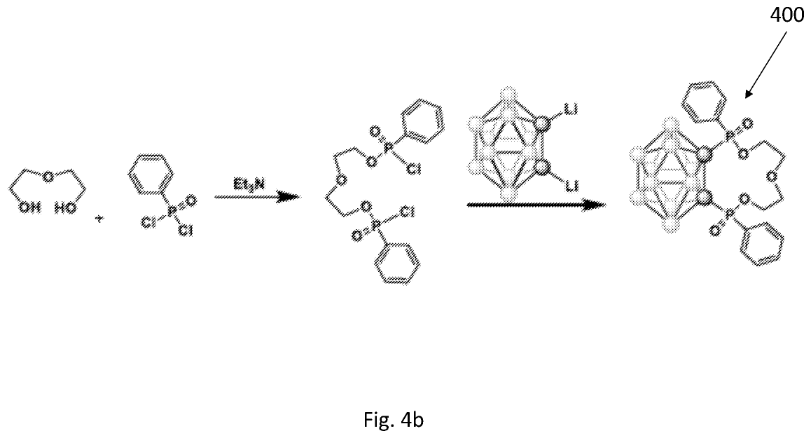

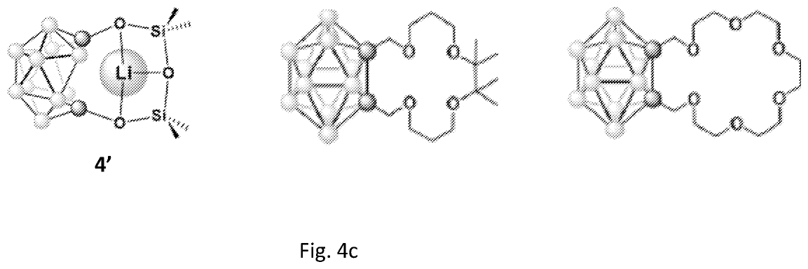

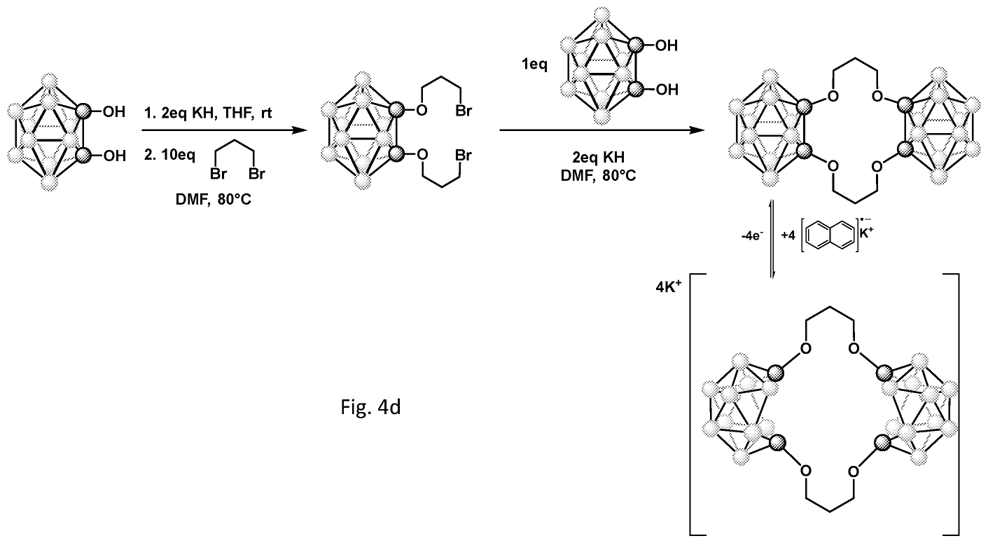

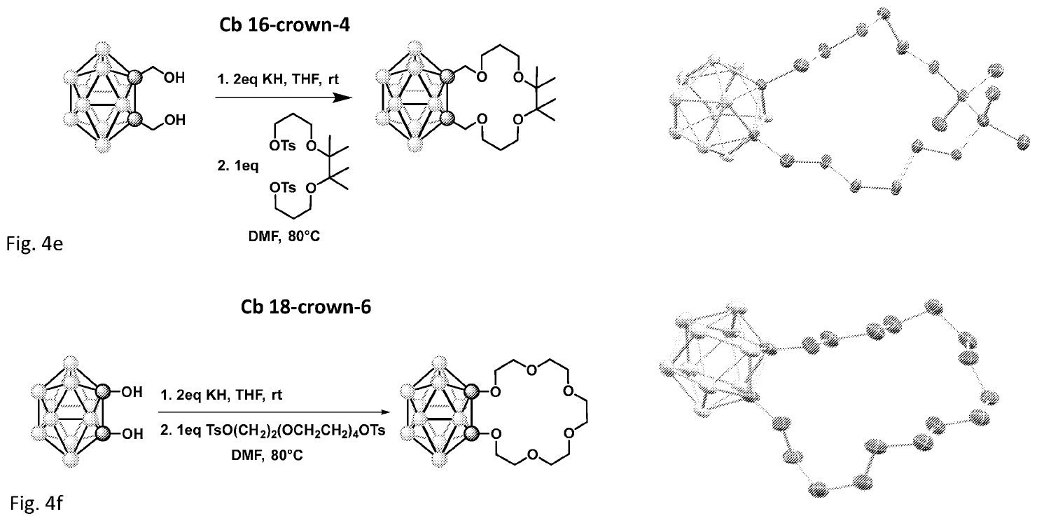

Mono- or bis-Cb 14-crown-4 mimics (with and without second Cb) can be prepared through the deprotonation of the reported dihydroxy-Cb, B₁₀H₁₀(COH)₂, using base (e.g., KH) to yield B₁₀H₁₀(COK)₂.¹² Treatment of this with the reported poly-ether, TsO(CH₂)₃O(CH₂)₂O(CH₂)₃OTs,¹³ affords 3 (without Li, FIG. 2) (FIG. 4a shows the synthesis of mono-Cb 14-crown-4 compound 1). The bis-Cb analog was synthesized by treatment of B₁₀H₁₀(COK)₂ to excess 1,3-dibromopropane to yield B₁₀H₁₀(COCH₂CH₂CH₂Br)₂, followed by treatment of it to B₁₀H₁₀(COK)₂ to yield the bis-Cb variant of 3 (FIG. 4d).

Similarly, Cb can be cyclized with tunable poly-ethers to afford Cb macrocycles with other functional groups such as phenyl phosphine oxide (4) to optimize Cb crown system through improving lithium binding affinity, selectivity, redox recycle and water stability. For example, the reaction of diethylene glycol, O((CH₂)₂OH)₂, with phenylphosphonic dichloride (PhPOCl₂) results in the formation of the poly-ether (ClPh)PO(O(CH₂)₂O(CH₂)₂O)PO(PhCl). Addition of this poly-ether to ortho-carborane B₁₀H₁₀(CH)₂ in the presence of base is expected to afford the crown variant 4. FIG. 4b shows the synthetic pathway to a carborane phosphine oxide crown example compound.

Smaller Cb crowns may be generated using a similar approach by treatment of B₁₀H₁₀(COK)₂ to the commercial disiloxane compound, O(Me₂SiCl)₂, to afford 4′ (without Li, structure shown in FIG. 4c). For this type of small crown, it is proposed that Li⁺ binding will be more efficient in the depicted nido form of 4′ with release occurring in the sterically congested closo form. Larger derivatized Cb crowns, targeting the second proposed binding pathway, may be generated using a similar approach by treatment of B₁₀H₁₀(COK)₂ with longer chain poly-ethers such as TSO(CH₂)₂O(CH₂)₂O(CH₂)₂O(CH₂)₂O(CH₂)₂OTs to afford mono-Cb 18-crown-6 (synthesis pathway shown in FIG. 4f). Without being bound by a particular scientific theory, for this type of large crown, the Li⁺ binding may be more effective in the closo form and release may occur in the expanded cavity nido form (FIG. 2a). Given the wide breadth of commercially available polyether fragments, this methodology is easily applied to access a variety of Cb crowns, thus providing a tunable platform for selectivity.

The carborane cage can readily be tuned to control the reduction potential by modifying select B—H fragments with B—X (X═I, Br, Cl, alkyl, aryl, SH) using known procedures.¹⁴

### Example: Compositions Comprising Carborane 14-Crown-4

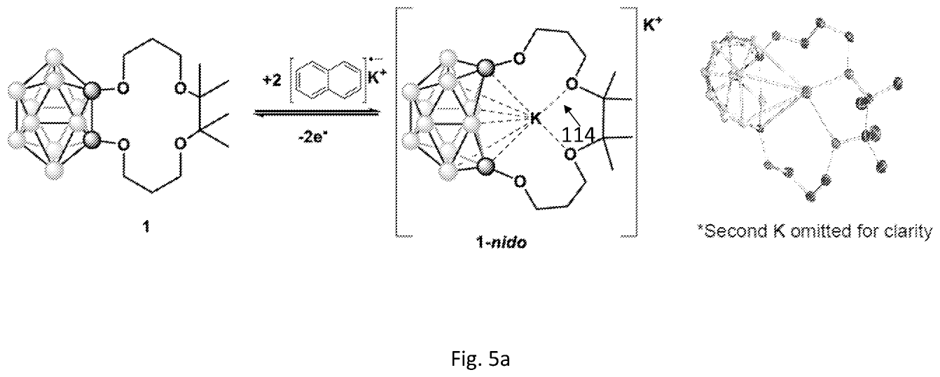

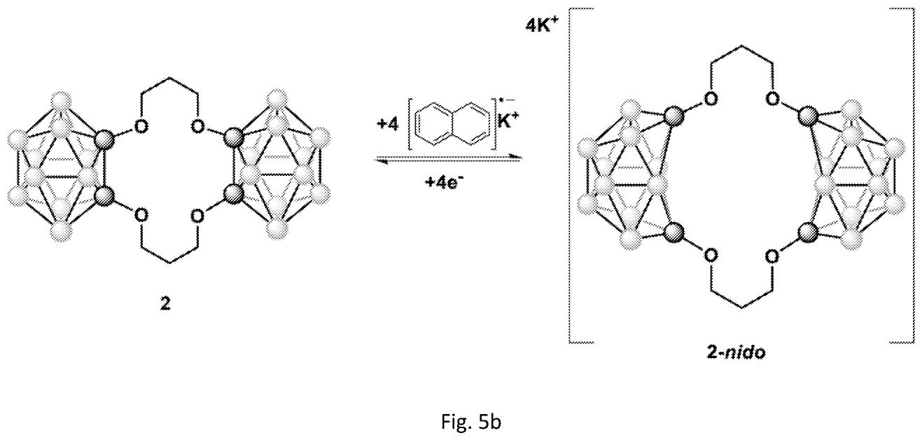

FIG. 5a and FIG. 5b illustrate two closo-carborane 14-crown-4 compounds and their nido- forms that were synthesized to test carborane-based species for selective lithium capture/release. Both compounds 1 and 2 have very negative reduction potentials at −2.92 V and −2.84 V, respectively, vs. the ferrocene/ferrocenium (Fc/Fc⁺) redox couple as observed by cyclic voltammetry (CV). Chemical reduction to the nido- forms was achieved by adding the strong reductant, potassium napthalenide, in THF. The nido- forms can also be achieved by electrolysis. For example, by a galvanostatic bulk electrolysis on 1 in a tetrabutylammonium hexafluorophosphate solution in DMF. After charging for 24 hours, we saw complete conversion of 1 to 1-nido along with the formation of some side products characterized by NMR spectroscopy. In order to provide full access to the crown pocket, the K⁺ ions in 1-nido can be removed by kryptofix-222 or 18-crown-6 which are known to strongly bind K⁺, or exchange with TEA⁺ using tetraethylammonium bromide.

The ¹H NMR spectrum for 1 revealed upfield shifted resonances following reduction to 1-nido. Similarly, the ¹H NMR spectrum of 2 revealed upfield shifted resonances upon reduction to the 2-nido product.

The presence of Lithium captured by the compound can also be identified by lithium peaks or resonance in the NMR spectrum. Using ⁷Li NMR, the coordinating abilities of our carboranes to Li in organic solvents using the soluble lithium salt, LiTFAB (TFAB=[B(C₆F₅)₄]⁻=non-coordinating anion) was studied. To probe for selectivity, competing group 1 ions, in the form of NaTFAB and KTFAB, were also studied as detailed below.

a. Lithium Capture in Closo Form

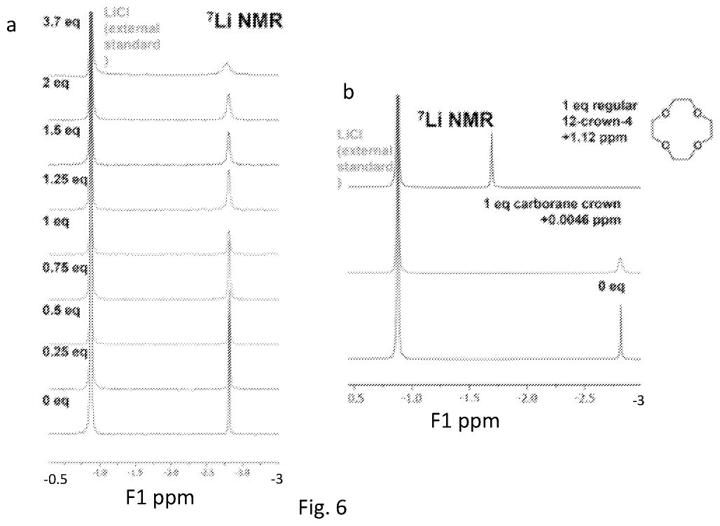

FIG. 6a shows that as the ratio of 1:LiTFAB is increased, the Li, resonance in the NMR spectrum became broader and shifted slightly downfield, which confirmed the existence of a Li⁺ interaction with the compound 1. However, the chemical shift of the Li⁺ resonance only changed slightly as more 1 was added. FIG. 6b, on the other hand, shows the addition of 1 equivalent of regular 12-crown-4 (known to be a good chelating agent for Li⁺—to LiTFAB) resulted in a shifted Li⁺ resonance by 1.12 ppm, significantly more than was observed for the 1 compound.

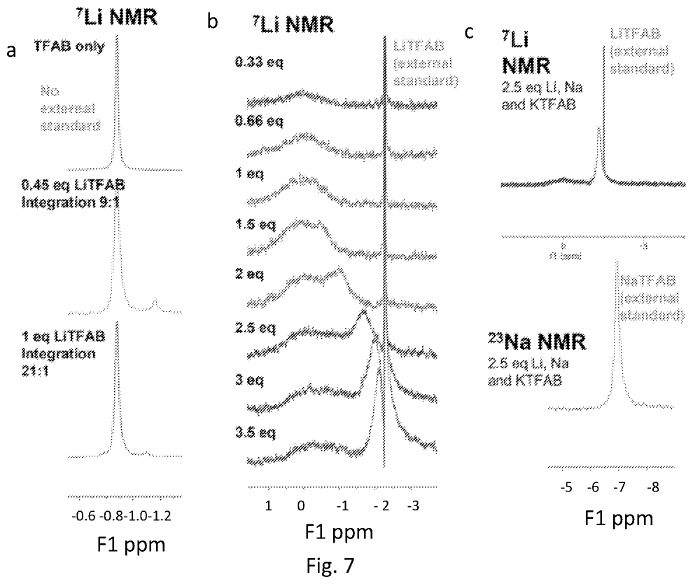

The ⁷Li NMR spectroscopy in FIG. 7a shows the closo form of compound 2 exhibits insignificant crown/Li⁺ interactions with increasing equivalents of LiTFAB.

These NMR data suggest that the dmso forms of compounds 1 and 2 have relatively weaker Li, binding affinity (small binding constant), which is beneficial for the Li, release step. Thus, selective Li⁺ capture would be governed by the nido form, whereas facile release would occur in the closo form.

b. Lithium Capture in Nido-Form

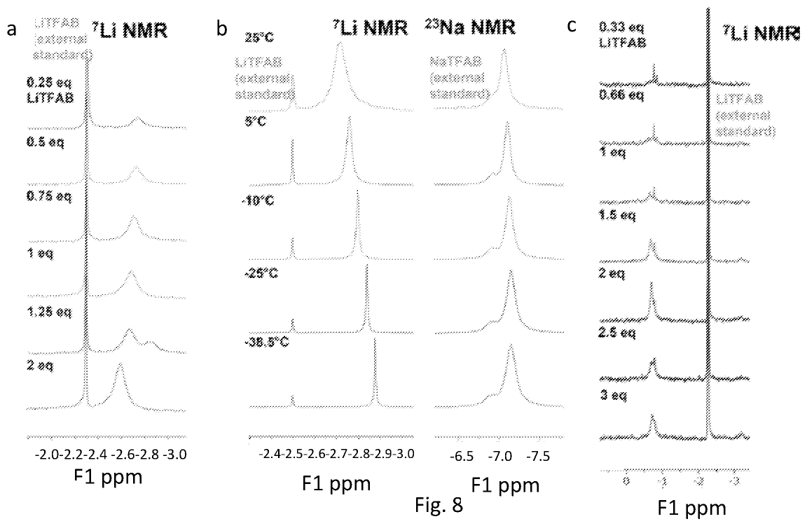

FIG. 8c shows new Li⁺ peaks in the NMR appeared and increased in intensity upon increasing the amount of LiTFAB, evidencing significantly increased Li capture using the 1-nido form as compared to the crown/Li⁺ interactions observed for the 1-closo form.

Similarly, the broad shifted Li+ resonances in FIG. 7b for the 2-nido evidence interaction with Li. When 2.5 equivalent of each of LiTFAB. NaTFAB, and KTFAB were added, only the Li⁺ resonances shifted (FIG. 7c), indicating selectivity for Li.

c. Lithium Capture in the Presence of a Solvent Comprising a Lithium Salt and a More Redox Stable Anion

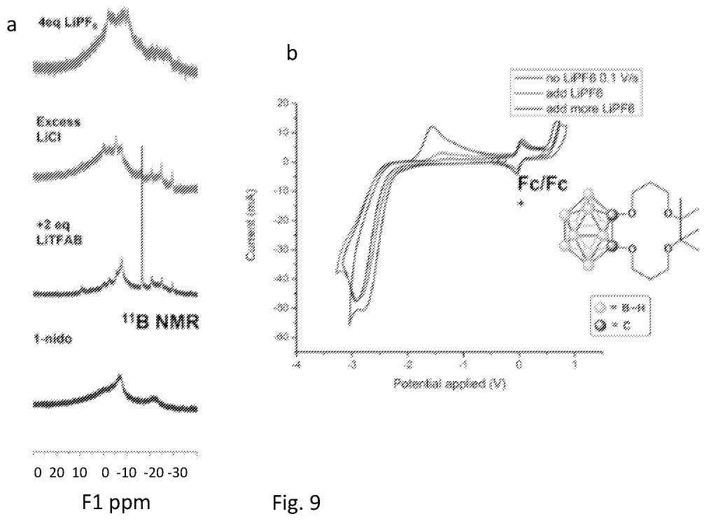

¹¹B NMR spectra from reactions of 1-nido with LiTFAB and LiCl show a new set of boron peaks that may result from unwanted deboronation reactions (FIG. 9a). ¹¹B NMR spectrum of the 1-nido in the presence of LiPF₆ shows that peaks associated with degradation of the carborane compound are much less pronounced, thereby indicating the LiPF₆ is a lithium salt with a more redox stable anion.

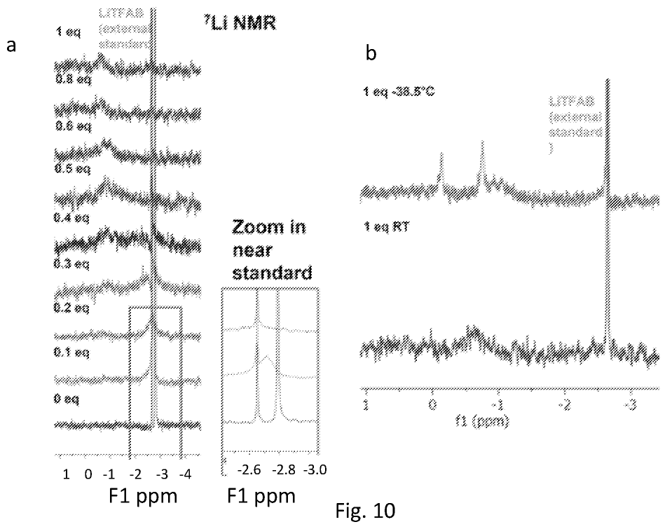

As we increased the ratio of 1-nido to LiPF₆, the Li⁺ resonance shifted significantly downfield as shown in FIG. 10a. The change of the chemical shift of the Li resonance, with 1 equivalent of 1-nido, is 3.416 ppm, more than the 1.12 ppm observed for 12-crown-4 and significantly more than the 0.0046 ppm shift for the closo form 1 (FIG. 6b). This data indicates that 1-nido has a strong Li⁺ binding affinity. The Li⁺ peaks became notably broader, suggesting multiple lithium environments may exist. These different environments could be observed upon collecting the spectrum at −38.5° C. revealing 2 sharp resonances (FIG. 10b). We suspect that one Li⁺ ion acts as an outer-sphere counter cation and the second Li⁺ ion is capture in the crown ether pocket, similar to what we observe with the two K⁺ ion environments in 1-nido.

d. Lithium Binding Affinity (as Compared to Sodium).

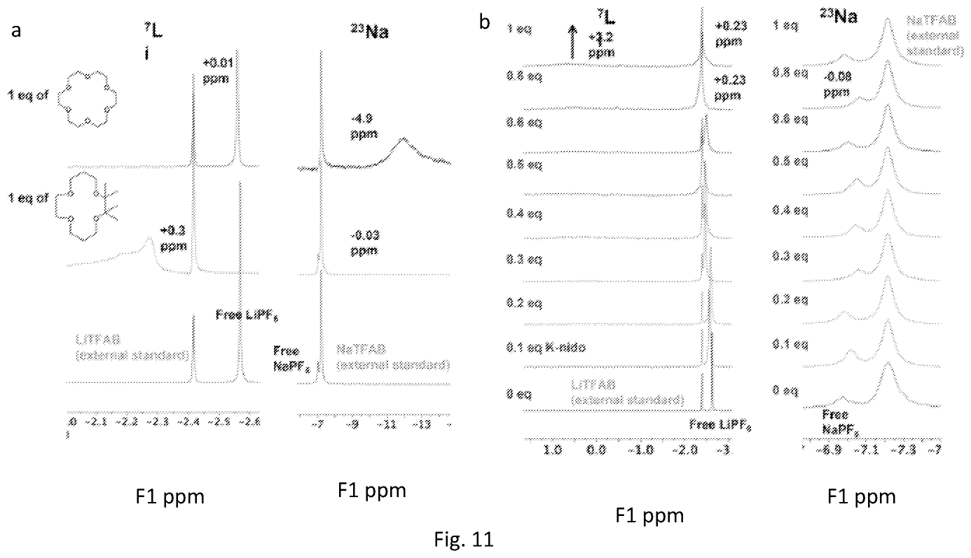

Several control studies were performed with reported crown ethers that have either high lithium or high sodium selectivity. We chemically synthesized the substituted 14-crown-4, which has similar structure as compound 1, to compare chemical shift changes in the ⁷Li and ²³Na NMR spectra (FIG. 11a). When 1 equivalent of 14-crown-4 was mixed with LiPF₆ and NaPF₆, the lithium resonance of the ⁷Li NMR spectrum shifted by 0.3 ppm downfield, whereas the sodium resonance shifted only −0.03 ppm in the ²³Na NMR spectrum. For 18-crown-6—which is known to have high Na over Li selectivity—the lithium resonance shifted by only 0.01 ppm whereas the sodium resonance shifted significantly by 4.9 ppm. The chemical shift changes from these control experiments indicate the NMR can be used to probe Lithium selectivity.

FIG. 11b shows the NMR spectra for the 1-nido species under the same conditions as the control experiment. The data shows that as we increased the ratio of 1-nido to LiPF₆, the Li⁺ resonance became broader and shifted downfield by 0.23 ppm, slightly less than 14-crown-4 control but much more than for the 18-crown-6 compound optimized for Na selectivity. In addition, we noticed a growth of another broader lithium signal near 0.5 ppm, which is 3.2 ppm shifted downfield from the free Li signal at 0 equivalent. The change in the ²³Na NMR is less significant with only a 0.08 ppm downfield shift with 0.8 equivalent of 1-nido added, showing a higher sodium interaction relative to 14-crown-4 but much lower interaction than for the 18-crown-6 compound. These combined NMR data indicate 1-nido has a higher selectivity for Li than Na.

e. Lithium Capture Studies in DMF Solvent

The lithium capture properties of synthesized 1-nido were also studied in the presence of an interaction with LiPF₆ in DMF under similar conditions as those for the MeCN-d₃ solvent used in examples a-d.

Procedure for Lithium Interaction Studies with 1-Nido in DMF:

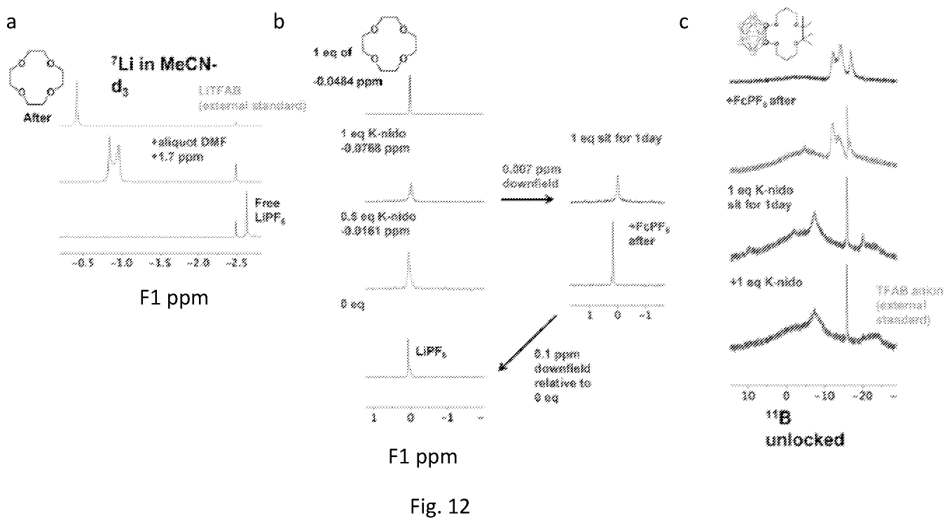

Separately, in an NMR tube, 0.006 M LiPF₆ solutions were mixed with different equivalents of 1-nido in DMF (not MeCN). A sealed capillary tube containing LiTFAB in MeCN-d₃ was then inserted into the NMR tube to serve as an external standard. Unlocked ¹¹B, ¹⁹F and ⁷Li NMR spectra were taken using different equivalents of 1-nido at 25° C. (FIG. 12b). As shown in FIG. 12b, the free LiPF₆ resonance is at approximately 0.1 ppm, which is more downfield shifted than for the NMR using the MeCN-d₃ solvent. As we added 0.5 and 1 equivalent 1-nido, the changes in chemical shift are 0.016 and 0.077 ppm, respectively. A control study of mixing 1 equivalent 12-crown-4 shifted the lithium resonance by 0.048 ppm, which is smaller than for 1 equivalent of 1-nido, further supporting strong lithium affinity with 1-nido in DMF solvent.

After adding FcPF₆ to oxidize the 1-nido to the closo form, we observed a sharper lithium signal shifted downfield and closer to the free LiPF₆ peak, suggesting that the captured Li⁺ can be released due the relatively weaker interaction of lithium with the closo form.

Electrochemical selectivity studies in THF and Glyme also indicate binding preference for Li over Na or K by the carborane crowns. Binding constants can be extracted from CV and NMR spectra.

### Further Examples of Carborane Compounds

Studies have shown that reduction of closo-Cb to the nido-Cb results in rupture of the C—C bond, cage opening, and an increased bite angle.³⁸⁻⁴¹ The present disclosure describes how the carborane compound platform system can be tuned to target the selective capture and release of Li⁺ in a selective manner from a variety of mixed-metal aqueous solutions.

a. Modification of Carborane Cage

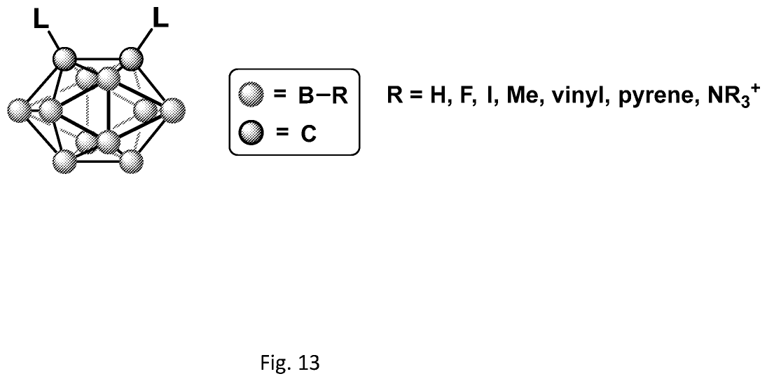

In one or more examples, the ten boron and two carbon atoms in the carborane compound are at fixed position for the selective capture and release of Li⁺. However, all ten hydrogens bonded to the boron atoms in the carborane cage can be selectively substituted with different functional groups, including but not limited to halogens, alkyl groups, aryl groups and amine/ammonium groups, with examples listed in FIG. 13. The modification can improve the carborane compounds' chemical stability, electrochemical stability, thermal stability and Li⁺ selectivity. For example, F-substitution can increase the stability of the carborane cage that losing a boron is less likely to occur during the synthesis and follow-up reactions. I-substitution can shift cage reduction potential more positively. Therefore, the reduced nido-form will be more stable in water for biphasic extraction. Each I-substitution can shift potential by 0.3V and up to 8 iodine can add on to a Cb cage. Methyl or ethyl substitution can increase the redox cycle reversibility of the Cb cage.

Attachment of vinyl or pyrene groups may be used for depositing Cb on to electrodes for electrochemical and heterogeneous lithium capture applications.

By introducing a formal positive charge group such as —NR₃⁺ group, the nido-form will have a charge of −1 instead of −2, leading the formation of the 1:1 Li⁺: nido-Cb adduct, which can simplify the lithium capture mechanism. In addition, the reduction potential can also shift significantly with the electron withdrawing —NR₃⁺.

b. Choices of Ligands for Lithium Capture

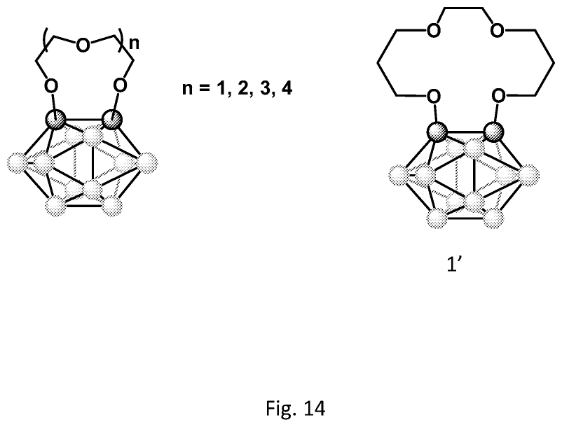

The type of the ligands that are bonded to Cb can significantly affect lithium capture efficiency and selectivity. FIG. 14 shows a ligand choice comprising a closed ring type ligand such as a crown ether. Example crown ethers (e.g., 12-crown-4 (FIG. 14, n=2) and 14-crown-4 (1′) can be considered first for their selectivity towards Li⁺.

The reduced nido-Cb cage can be another lithium coordination site in addition to the oxygen from the crown ether. Therefore, smaller crown size (9-crown-3, n=1) may further improve lithium selectivity in some applications. On the other hand, in other applications, the opened nido-Cb cage may change the crown ether lithium binding mode and bigger crown size, such as 15-crown-5 (n=3) and 18-crown-6 (n=4), may be more suitable for capturing lithium. Useful functional groups can also attach onto carbon to improve the lithium capture ability.

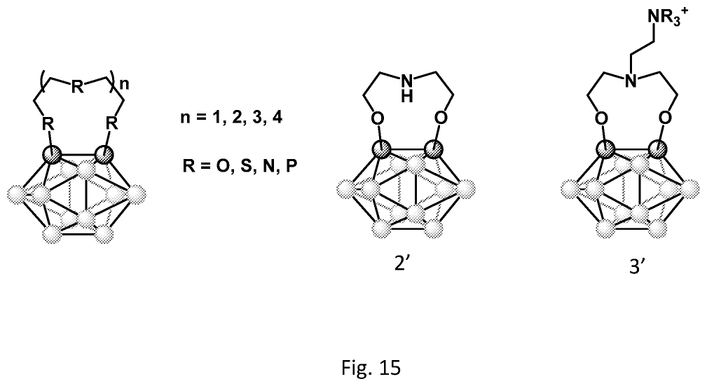

Oxygen from the crown ether can be replaced with other atoms that have lone pair electrons to bind lithium. FIG. 15 illustrates macrocycle ligands that are derivatives of crown ether containing S, N or P for coordinating lithium, and example of which azo-9-crown-3 (2′). In addition, a useful functional group can attach on to the nitrogen without affecting the lone pair electron. For example, a formal positive charged —NR₃⁺ group can add to the nitrogen on the macrocycle ligand (3′) instead of the above described substitution on the Cb cage and that are synthetically more challenging.

c. Addition of Spacer Group

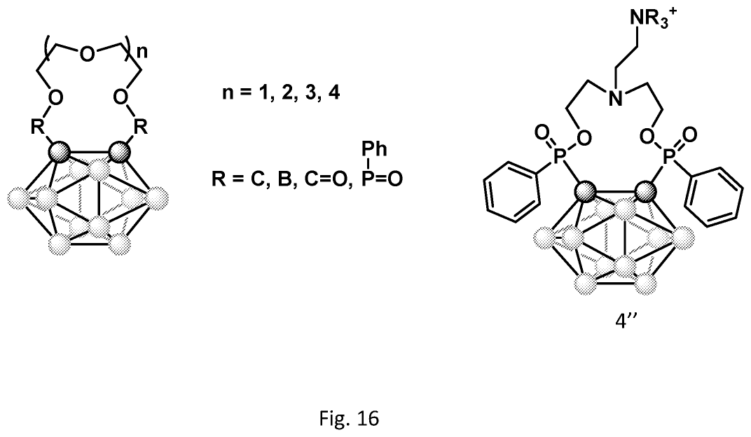

In some examples, the two oxygens that are bound on the Cb may not participate the lithium coordination in the nido form. To utilize all the oxygen in the crown ether, a spacer group such as a CH₂ and boron containing group can be added between the Cb and the crown ether, as illustrated in FIG. 16. Furthermore, an electron-withdrawing spacer group is more beneficial for shifting the reduction potential to be more water stable. For example, when the electron-withdrawing diphenyl phosphine oxide group is attached onto the carborane, the reduction potential is at −1.1 V and its nido-form is stable in water.⁴² We expect the compound formed by attaching an azo 9-crown-3 linker with formal positive —NR₃⁺ group onto the phosphine oxide Cb (4″) to perform stably, effectively, and selectively for electrochemical lithium capture/release in water. Other carbons in the crown ether can also be replaced by atoms or groups including CR₂, SiR₂, BR, C═O, PhP═O, NHC═O, NRC═O to further modify the carborane compound's electronic and steric property.

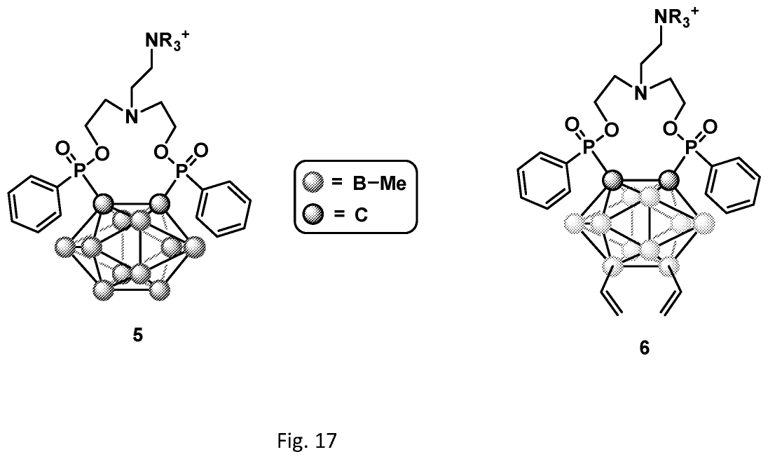

Methyl substitution of compound 4″, which leads to compound 5 (FIG. 17), can further increase long-term stability during multiple redox cycles of homogeneous and heterogeneous lithium capture/release. The addition of methyl groups on the cage increase the robustness of the cage while simultaneously shifting the redox potential anodically. Ortho-carborane can be functionalized with methyl groups at eight of the ten boron vertices by reacting it with methyl iodide in the presence of aluminum chloride for 4 days. Since boron is electropositive relative to methyl, each methyl group contributes a slight electron-withdrawing effect. We took the CV of octa-methyl carborane in THF and observed two one e⁻ reduction events at −1.09 V and −1.86 V versus Fc/Fc⁺. Compared to ortho-carborane (C₂B₁₀H₁₂), which has a reported potential of −2.96 V versus Fc/Fc⁺, adding the methyl groups appears to shift the redox potential substantially. We expect that the methyl groups will also prevent cage degradation due to the stronger bonding between boron and carbon relative to boron and hydrogen.

By modifying the compound 4′ with attachment of two vinyl groups (6), the Cb crown system can be anchored to a carbon electrode in a heterogeneous electrochemical lithium recycling application. Various other functional groups can be attached to the carborane compound for anchoring to an Au electrode, a carbon electrode, ITO electrode etc.

d. Two (Bis) Cb Cage System.

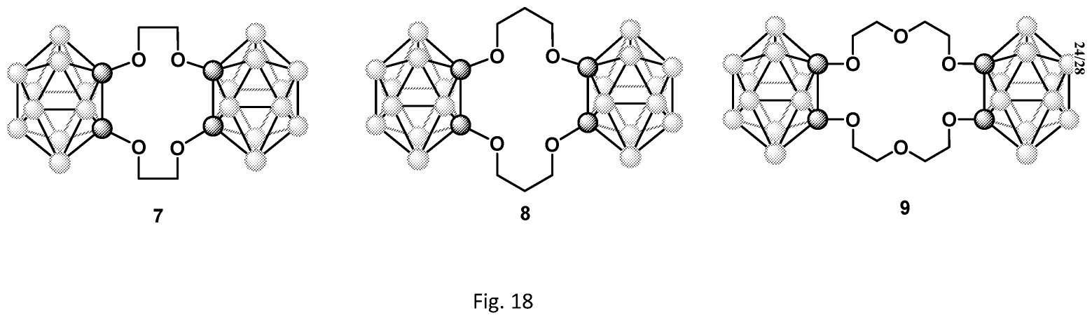

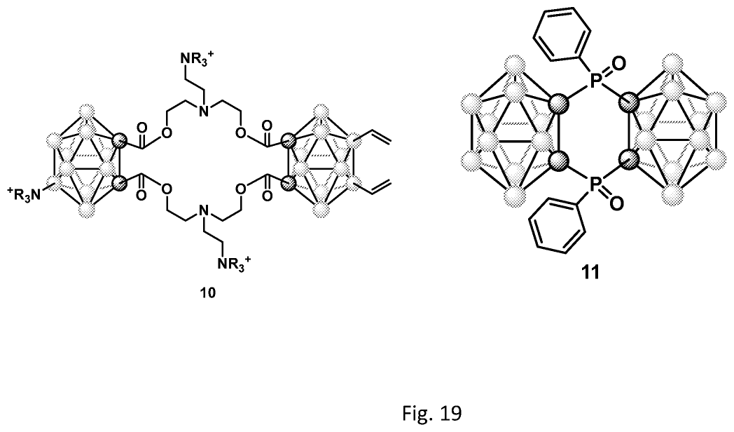

Another option for closed ring type ligand features two Cb cages, by connecting two Cb with a crown ether—examples include, but are not limited to, 12-crown-4 (7), 14-crown-4 (8) and 18-crown-6 (9), as illustrated in FIG. 18. The electron withdrawing Cb cage can contribute to reduction potential shift and further open the crown ether in nido-form. The above described cage substitutions, crown ether functionalization, and spacer group addition can all be applied to the two-Cb system (see e.g., compound 10 in FIG. 19).

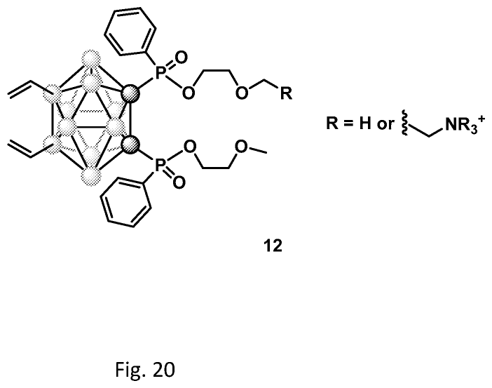

For the two Cb cage system, with two nido-Cb as strong coordination sites for lithium, there can be more options for Li⁺ bonding ligands on top of the crown ether. For example, the two Cb cage can be connected by phenyl phosphine oxide ligand (11, FIG. 20), where P═O can serve as lithium coordination sites at the nido form. To increase the distance between the two Cb cages, additional functional groups can be introduced.

e. Open Ligand System

To bind lithium selectively, ligand choices are not limited to closed ring types such as the crown ether. Open diphenyl phosphine oxide Cb species have shown success for Uranium capture.⁴² In some examples, a modified phosphine oxide ligand Cb system can be more suitable for capturing small size lithium. For example, compound 12 with cage substitution and functionalized ligand may be a useful Cb system for heterogeneous lithium capture (FIG. 20).

f. Compounds for Stabilizing in Water (Seawater)

Various strategies can be used to shift reduction potentials and further improve carborane crown system stability. We have shown that closo-diphenylphosphine oxide carboranes possess a cathodic event at −1.1 V versus Fc/Fc⁺. The corresponding nido-diphenylphosphine oxide carborane is water stable and able to capture uranyl in a biphasic system. For lithium selectivity, phenylphosphine oxide 1l-crown-3 carborane can be used. Scheme 1 below shows a synthetic method through deprotonation of ortho-carborane with n-butyllithium followed by addition of dichlorophenylphosphine oxide. Subsequent deprotonation with KH and addition of diethylene glycol can produce the desired 1l-crown-3 carborane with a phosphine oxide spacer. We expect this crown size will be optimal for capturing lithium selectively in the nido form and releasing in the closo form, while being water stable and having a strongly anodically shifted reduction potential.

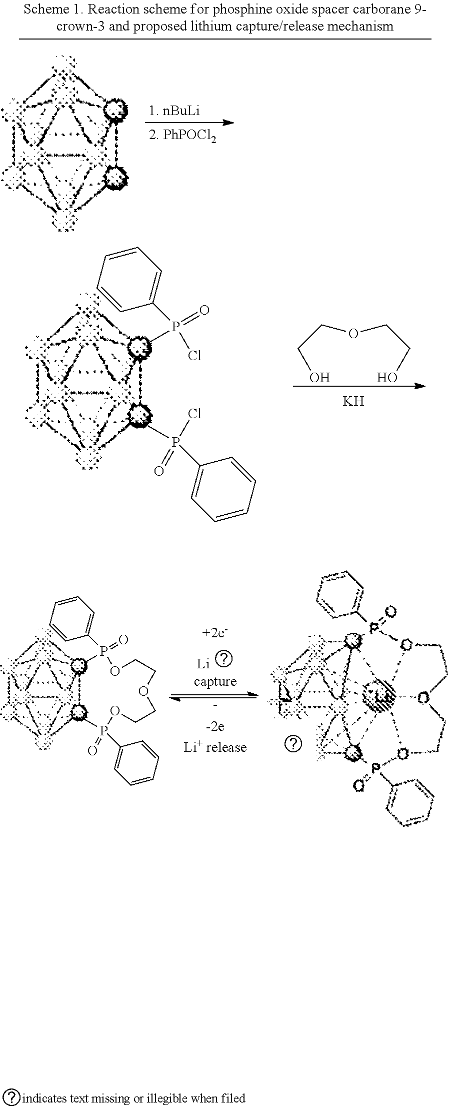

Alternatively, the nido-diphenylphosphine oxide carborane can be synthesized through addition of the phosphine oxide onto the diethylene glycol linker. Then, mixing the linker with deprotonated ortho-carborane should result in the desired product (see FIG. 4b for synthetic pathway to carborane phosphine oxide crown).

### Process Steps

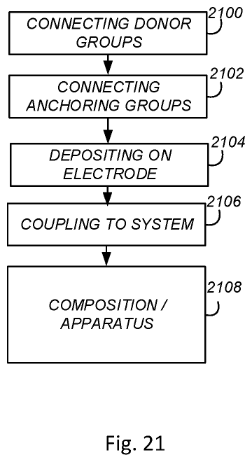

FIG. 21 is a flowchart illustrating a method of making a composition of matter according to embodiments described herein.

Block 2100 represents connecting a lithium capturing ligand or donor group to a carborane (Cb) or a carbon (C) containing compound.

Block 2102 represents optionally connecting an anchoring group, e.g., at the 9- or 9,12-positions of the Cb. Examples include, but are not limited to, thiols for Au-SAMs or vinyls for carbon electrodes. The anchoring groups can be installed before or after the donating groups.

In one example, the thiols 9-(HS)B₁₀H₁₁C₂, 9,12-(HS)₂B₁₀H₁₀C₂,¹⁶⁻¹⁷ or 9,12-(p-MeSC₆H₄)₂B₁₀H₁₀C₂¹⁸ can be prepared and protected,¹⁹⁻²² followed by installation of the donor groups, then followed by deprotection.^{14, 20-22}

In another example, Cb/Au-SAMs can be prepared following reported procedures²³⁻²⁵ and characterized by: electrochemical impedance spectroscopy to identify surface modifications²⁶; X-ray photoelectron spectroscopy to identify the elements and their local environments²⁷⁻²⁸; surface-enhanced Raman spectroscopy to determine diagnostic functional group features,²⁹ and; scanning tunneling microscopy to characterize the orientations of the surface-bound Cbs.^{28, 30}

Despite their simplicity and ease of preparation, in some applications, Au-SAMs can suffer from long-term instability.³¹⁻³² In such applications, covalent grafting on C may be used instead. The vinyl groups outlined (FIG. 3c) are readily synthesized from 9-I-B₁₀H₁₁C₂ by cross-coupling.³³⁻³⁵ These vinyl-Cbs can be immobilized onto C surfaces, such as glassy carbon, by initial surface homolytic C—H activation using known procedures.³⁶

Block 2104 represents optionally depositing the composition on an electrode to form a functionalized electrode suitable for metal capture and release. Static solution metal capture experiments and electrode characterization can be used to optimize electrode materials and conditions useful for quantitative metal capture and release from aqueous media—and eventually seawater—using a flow cell.

In one or more examples, the working electrodes are formed into flow fields³⁷ for continuous selective metal capture at an applied potential, followed by release at an opposite potential, as illustrate in FIG. 3a. In one example, high surface area Au-plated stainless steel electrodes are used for the Cb/Au SAM electrodes (FIG. 3b). In another example, high surface area carbon foam electrodes are used for vinyl-functionalized Cb/C electrodes (FIG. 3c).

Block 2106 represents coupling the functionalized electrode in a flow cell system. In one example, the flow cell system comprises a packed-bed type flow-through or a flow-by design.⁴ A solid-state sacrificial counter electrode, such as activated carbon, can be used for measurements or monitoring of lithium capture. In one or more examples, metal concentration in the flow cell solution can be determined by UV-Vis spectroscopy, cathodic stripping voltammetry,³⁸ and verified ex-situ by standard ICP-OES techniques.⁴⁻⁵

Block 2108 represents the end result, a composition of matter or apparatus comprising the composition of matter. Illustrative embodiments of the composition of matter, method, or apparatus include, but are not limited to, the following examples (referring also to FIGS. 1-22).
1. A composition of matter 100 useful for capturing lithium (Li), e.g., lithium ion(s), comprising:s
   a carborane compound 102 bonded to one or more (e.g., lithium selective) donor groups L, wherein:
   the carborane compound comprises a structure 103 (e.g., cage structure) that can be modulated electrochemically via application of a current, the current activating a redox reaction switching the structure between a closed state 104 (e.g., closo state) and an open state 106 (e.g., nido),
   the switching comprises a rupture of a carbon-carbon (C—C) bond 108 resulting in opening of the structure from the closed state to 104 the open state 106; and
   the donor groups L comprise a moiety:
      for capturing one or more lithium ions Li, 105 from a liquid 306 in contact with the donor groups L in the open state 106 and releasing the lithium ions in the closed state, 104 or
      for capturing the one or more lithium ions from the liquid in contact with the donor groups in the closed state and releasing the lithium ions in the open state.
2. The composition of matter of example 1, further comprising an anchoring group 304 for anchoring to an electrode.
3. The composition of matter of example 1 or 2, wherein the one or more donor groups L comprise a macrocyclic group.
4. The composition of matter of example 1 or 2, wherein the one or more donor groups L comprise a crown ether.
5. The composition of matter of example 1 or 2, wherein the one or more donor groups L comprise an acyclic group.
6. The composition of matter of any of the examples 1-5, wherein the one or more donor groups L comprise Li⁺ binding ligands 107 (or the ligands 107 comprise a donor group L) or Li⁺-selective donor groups.
7. The composition of matter of example 1 or 2, wherein the carborane compound 102 is:
mono-carborane 14-crown-4 that can be reduced to its open state (nido-form 1-nido) using the electrochemical reaction, or
bis-carborane 14-crown-4 (2) that can be reduced to its open state (nido- form, 2-nido) using the electrochemical reaction.
8. The composition of matter of example 1 or 2, wherein the donor compounds L comprise a ring and the redox reaction rupturing the C—C bond 108 expands the size of the ring and/or the cavity 109 of the ring to match or mismatch to a coordinate bond length 114 suitable for bonding to the lithium ion.
9. The composition of matter of any of the examples 1-8 in contact with the liquid 306 comprising a mixture of ions, a Li-rich brine, seawater, underground water, or an organic solution.
10. The composition of matter of any of the examples 1-9, wherein the carborane compound 102 and the donor groups L are configured to selectively bind to the lithium ions over Na⁺ and K⁺.
11. The composition of matter of any of the examples 1-10, wherein the carborane compound 102 in the open state comprises carbanions 110 and the carborane compound further comprises one or more electron withdrawing groups 400 bonded to the carborane compound, wherein the electron withdrawing groups suppress oxidation of the carbanions 110 in water (e.g., seawater) or air (or the liquid containing the lithium ions).
12. The composition of matter of any of the examples 1-11, further comprising a stabilizing compound 400 comprising phosphine oxide bonded to the carborane compound.
13. The composition of matter of any of the examples 1-12, wherein:
(a) in the closed state 104, a separation 112 between the donor groups L and the lithium ion is mis-matched to a coordinate bond length 114 for binding the donor group to the lithium ion, and in the open state, the separation 112 is matched to the coordinate bond length 114, or
(b) in the open state 106, the separation 112 is mismatched to the coordinate bond length 114 and in the closed state 104 the separation is matched to the coordinate bond length.
14. The composition of matter of any of the examples 1-13, wherein the carborane in the open state comprises carbanions 110.
15. An apparatus 300 for capturing lithium from a liquid 306, comprising:
   a circuit 302 comprising an electrode;
   a plurality of compounds 100 each comprising a carborane and one or more donor groups L bonded to the carborane, wherein each of the carboranes:
   are attached to the electrode 305, and
   have a first state 104(106) and a second state 106(104); and
wherein the circuit 302 is configured to:
   apply a current to the electrode 305 in contact with the liquid to switch from the first state to the second state; and
   reverse a polarity of the current to switch from the second state to the first state so that:
   in the first state the one or more donor groups L bind to one or more lithium ions 105 in the liquid 306 and in the second state the one or more donor groups release the one or more lithium ions.
16. The composition of matter of example 15, wherein the carborane 100 each comprise a structure 104 that can be modulated electrochemically via the current activating a redox reaction switching the structure between the first state comprising a closed state 104 and the second state comprising an open state 106, wherein the switching comprises a rupture of a C—C bond 108 in the structure resulting in opening of the structure from the first state to the second state.

17. The apparatus of example 15, wherein:
the circuit is configured to set the polarity of the current to modulate a redox reaction switching the carborane between the first state and the second state,
the one or more donor groups L bind to the lithium ions 105 when the carborane 100 is in the first state associated with a C—C bond in the carborane formed by the current having a first polarity, and
release the lithium ions when the carborane 100 is in the second state associated with the C—C bond in the carborane ruptured in response to the current having the second polarity opposite the first polarity.
18. The apparatus of example 15, wherein:
the circuit 302 is configured to set the polarity of the current modulating a redox reaction switching the carborane between the first state and the second state,
the one or more donor groups L release the lithium ions when the carborane is in the first state associated with a C—C bond 108 in the carborane 100 formed by the current having a first polarity, and
bind to the lithium ions 105 when the carborane is in the second state associated with the C—C bond 108 in the carborane ruptured in response to the current having the second polarity opposite the first polarity.
19. The apparatus of example 15, wherein:
the first state comprises a closed state 104 of the carborane wherein a C—C bond 108 in the carborane 100 is formed,
the second state comprises an open state 106 of the carborane 100 wherein the C—C bond is ruptured, the circuit is configurable to:
set the current modulating binding capability of the donor groups L to the lithium ions 105 by modulating at least one of an electronic state or a size of each of the donor groups, and
   set the current activating the redox reaction rupturing the C—C bond 108 in the carborane 100 in the first state to form the carborane 100 in the second state comprising two carbanions 110 that position the donor groups L to match the separation 112 of the donor groups to the lithium ions to a coordinate bond length 114 for lithium ion binding, thereby enhancing binding of the donor groups L to the one or more lithium ions, or
   the current activating the redox reaction rupturing the C—C bond 108 associated with the closed state 104, to expand the donor compounds and form the open state 106, wherein the donor compounds in the closed state have a (cavity 109) size or separation 112 from the lithium ions better matched for stronger binding to the lithium ions as compared to when the carborane is in the open state 106.
20. The apparatus of any of the examples 15-19, wherein the liquid 306 comprises a mixture of ions, a Li-rich brine, seawater, underground water, or an organic solution.
21. The apparatus of any of the example 15-20 wherein the donor groups L comprise a crown ether.
22. The apparatus of any of the examples 15-21, wherein the compounds 100 comprise at least one of the following structures:

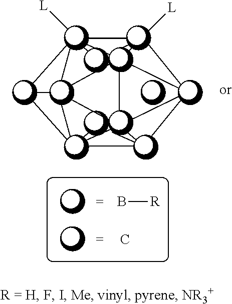

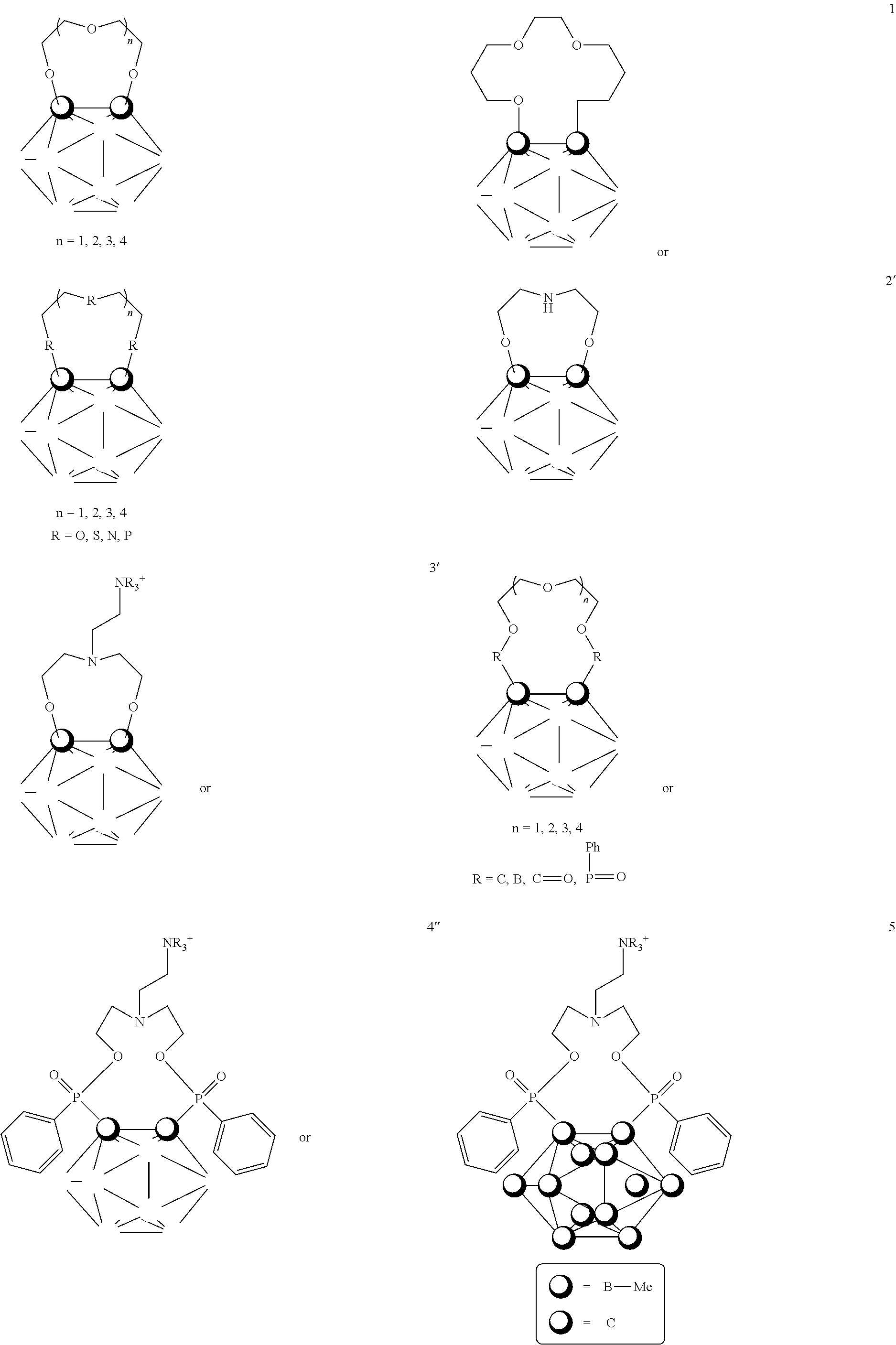

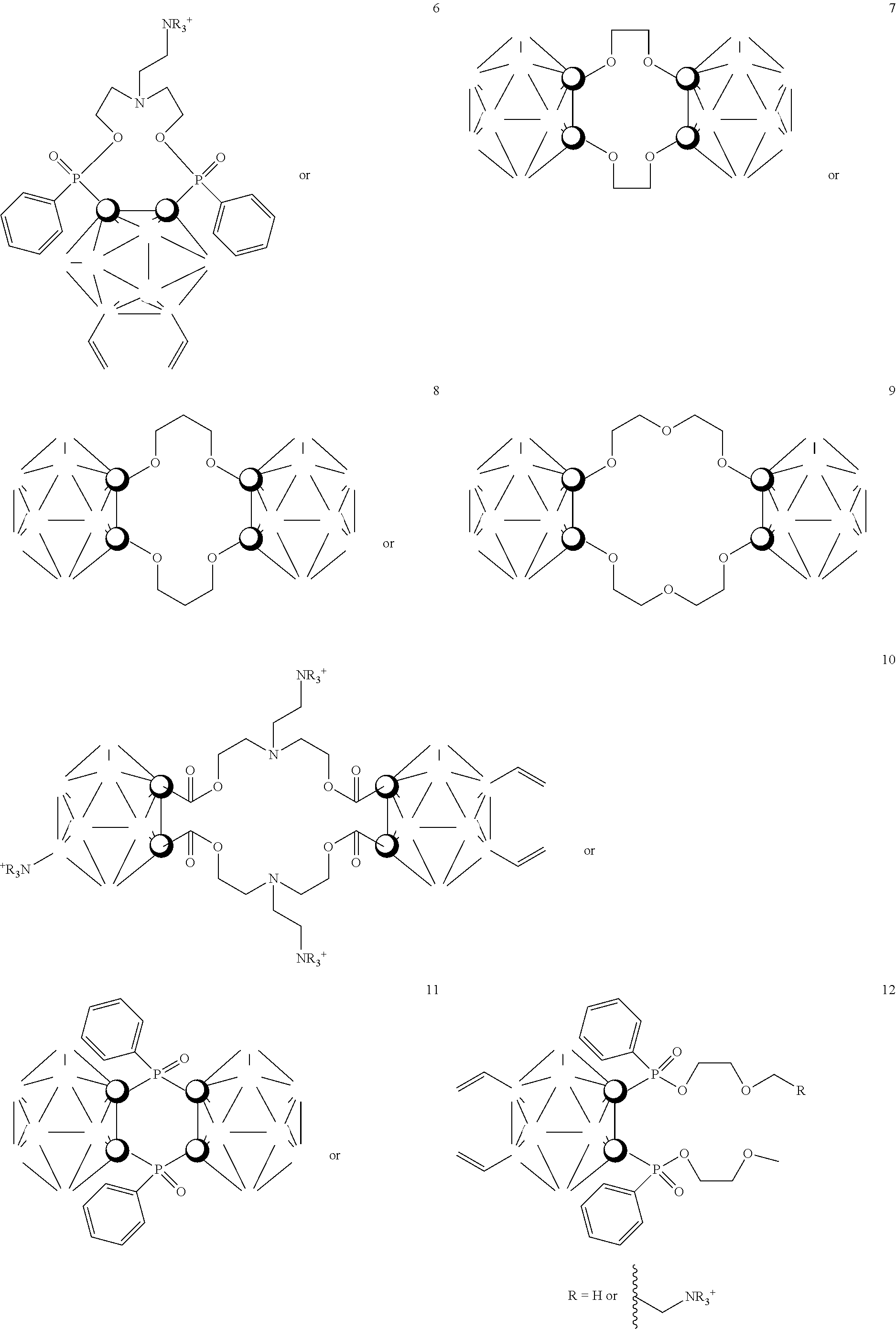

23. The apparatus of any of the examples 15-22, further comprising an eluent liquid 308 or other storage medium, wherein the lithium ions released by the donor groups in the first or second state are released to the eluent liquid or the storage medium.
24. A composition of matter 100 useful for capturing lithium ions, comprising a compound of the structure:

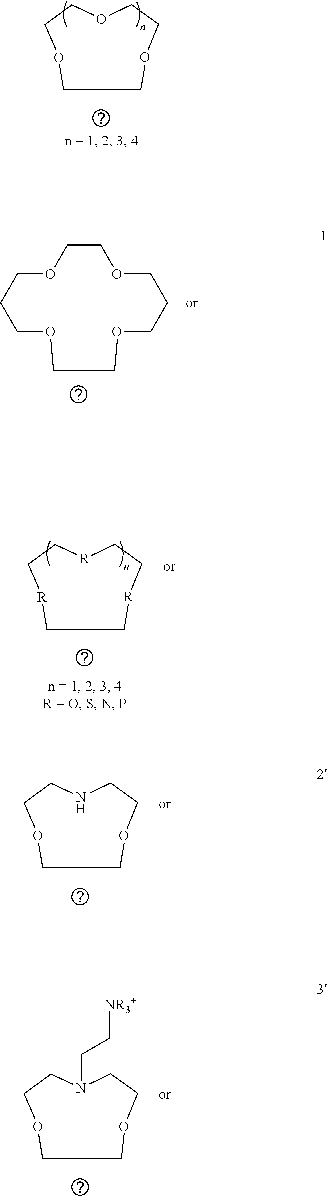

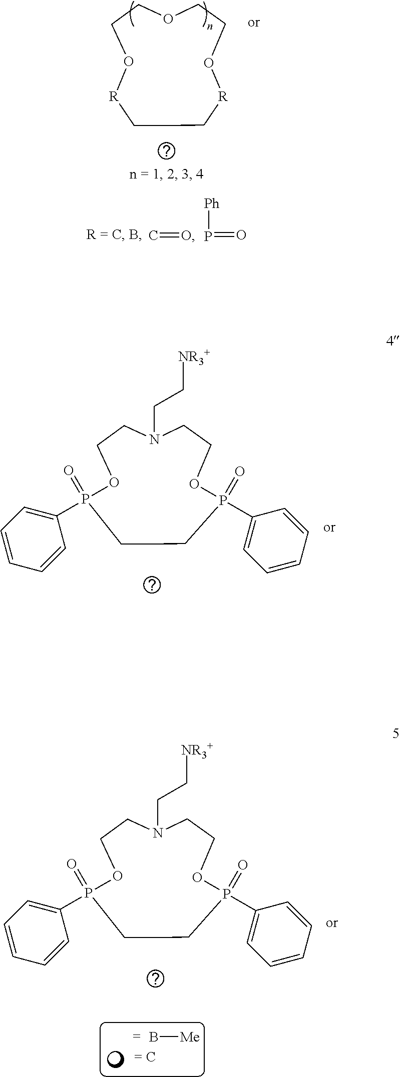

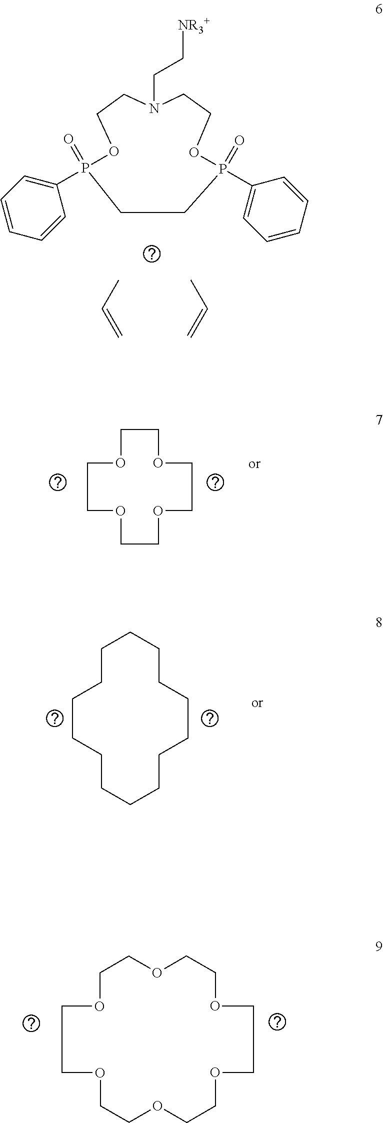

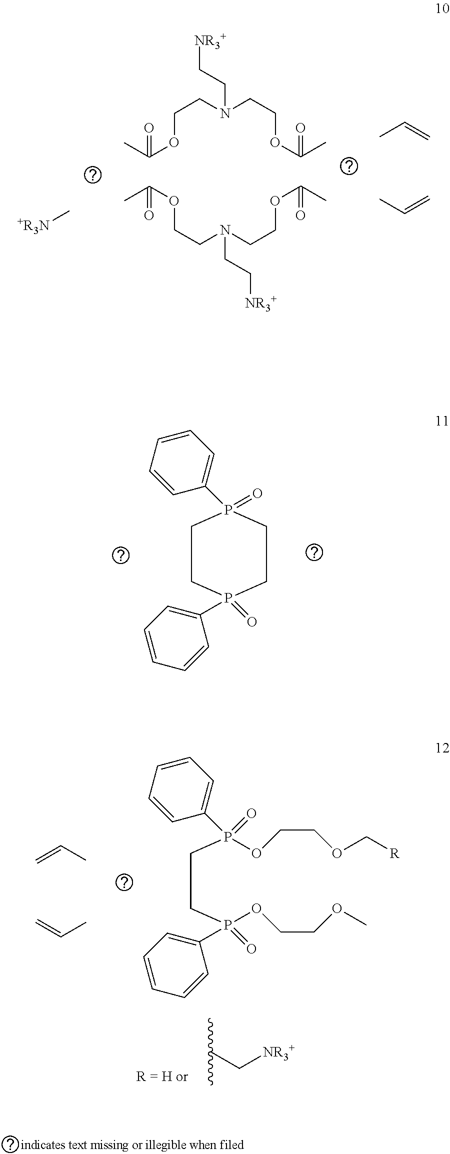

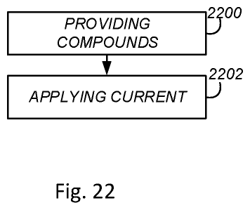

25. FIG. 22 illustrates a method for capturing and releasing a lithium ion, comprising:
   providing (Block 2200) compounds each comprising one or more donor groups bonded to a carborane, wherein the carborane is attached to an electrode; and
   applying (Block 2202) a current to the electrode in contact with a liquid so as to change a shape and/or configuration of the carborane between a first state and a second state, comprising:
   setting a first polarity of the current configuring the carborane in a first state wherein the one or more donor groups may bind to a lithium ion in the liquid; and
   setting a second polarity of the current configuring the carborane to the second state wherein the one or more donor groups release the lithium ion.
26. A composition of matter, comprising:
one or more donor groups each configured to form a coordinate bond with a lithium ion;
means for controlling a separation of the donor groups to the lithium ions, wherein the means is bonded to the donor groups and is configurable to control the separation to match or mis-match with a coordinate bond length associated with formation of the coordinate bond.
27. The composition of matter of example 26, wherein the means for controlling comprises a carborane having a C—C bond and the carborane can be reversibly switched between a first state when the C—C bond is formed and a second state when the C—C bond is ruptured to form carbanions.
28. The method, apparatus, or composition of any of the examples 1-27, further comprising one or more ligands 107 or chelating agent 107 comprising the donor groups L, wherein the ligands or chelating agents form coordinate bonds 111 with the lithium ions.
29. The method, apparatus, or composition of matter of any of the examples 1-28, wherein the chelating agents or ligands comprise one or more heteroatoms (selected from oxygen O, sulfur S, Nitogen N, or phosphorus P) separated by one or more carbon C atoms, wherein a number of the carbon atoms and the heteroatoms are selected so that the separation between the heteroatom and the lithium atom is:
a. tuned or matched to the coordinate bond length 114 for the coordinate bond Ill formed between the heteroatom and the lithium ion, thereby optimizing capture of the lithium ion in a lithium capture configuration 104, 106 of the carborane compound (closed 104 or open state 106), and
b. mismatched from the coordinate bond length in the release configuration of the carborane compound (open or closed state), so that the coordinate bonding between the lithium ion and the heteroatom is disfavored and the lithium ion is released from the heteroatom.
30. The method, apparatus, or composition of matter of example 29, wherein the ligand or chelating agent comprises an organic/hydrocarbon ring or crown comprising the carbon atoms and the heteroatoms, and the (cavity) size or diameter of the ring is tuned or selected to match or optimize the coordinate bond length in the lithium capture configuration (e.g., coordinate bond length of 2.88 Angstroms for the case of an O—Li bond).
31. The method, apparatus, or composition of any of the examples 1-30, further comprising at least one of a spacer group 400 between each of the donor groups and the carborane, or an R group bonded to one or more of the boron atoms in the carborane, wherein the rupture of the carbon bonds forms carbanions and at least one of the R or the spacer group comprise an electron withdrawing group accepting electrons so as to suppress reaction (e.g., oxidation) of the carbanions with air or the solvent comprising the lithium ion, thereby maintaining stability of the carbanion in the solvent (e.g., water, seawater) or air (and preventing the carbanions from reducing oxygen or water or dissociation/degradation of the carborane).
32. The method, apparatus, or composition of any of the examples 1-31, wherein the electron withdrawing group forms the carborane compound having a reduction potential, in the solvent containing the lithium ions, that is more positive than −1.1 V vs. the ferrocene/ferrocenium (Fc/Fc⁺) redox couple.
33. The method, apparatus, or composition of any of the examples 1-32, wherein the spacer group, R group bonded to the boron, or the electron withdrawing group comprises R-phosphine oxide (R=phenyl, for example), a sulfone, a sulfoxide, a ketone, an ester, a compound comprising carbon and fluorine. CF₃, CN, C═O, NO₂ or SO₂ (e.g., CF₂, CH—CF₃, C(CF₃)₂, CH—CN, C(CN)₂ etc.), or a methyl group, etc.
34. The method, apparatus, or composition of any of the examples 1-33, wherein the spacer group or the compound bonded to the boron is R-(EWG)ₙ, where EWG=any electron withdrawing group, including but not limited to F, Cl, Br, I, CN, CF₃, NO₂, sulfonate, ketone, ester, n=1, 2, 3 or 4. R can be a phenyl or substituted phenyl for example. In other examples, R is one of the following
35. The method, composition, or apparatus of any of the examples 1-34, wherein the chelating agents or ligands are configured to form, in the lithium capture state (104, or 106), the coordinate bond length selectively matched or tailored to the coordinate bond length for bonding to the lithium ion, as compared to that required for forming a coordinate bond to Na⁺ or K⁺.
36. The method, composition, or apparatus of any of the examples, e.g., any of the examples 1-35, wherein the carborane is replaced with a carbon containing compound with the open state 106 and a closed state 104, e.g. a compound comprising carbon and a heteroatom other than boron.
37. The apparatus of any of the examples 15-23 or the method of example 25 utilizing the composition of matter of any of the examples 1-14, 24, or 26-36.

### Advantages and Improvements

In one or more embodiments, only an applied electric current needs to be applied for the capture and release of Li from the lithium containing solvent/fluid (e.g., seawater). Most other technologies currently being investigated feature selective membranes that do not readily release Li after capture, thus requiring acidic workup for subsequent release. Devices according to embodiments described herein can instead release Li by only applying a current, thus requiring no stoichiometric reagents and no excessive waste.

### REFERENCES

The following references are incorporated by reference herein.
1. Sholl, D. S.; Lively, R. P. Seven chemical separations to change the world. Nature 2016, 532, 435-437.
2. Parker, B. F.; Zhang, Z.; Rao, L.; Arnold, J. An overview and recent progress in the chemistry of uranium extraction from seawater. Dalton Trans. 2018, 47, 639-644.
3. Loganathan, P.; Naidu, G.; Vigneswaran. S. Mining valuable minerals from seawater: a critical review. Environ. Sci. Water Res. Technol. 2017, 3, 37-53.
4. Battistel, A.; Palagonia, M. S.; Brogioli, D.; La Mantia. F.; Trócoli, R. Electrochemical Methods for Lithium Recovery: A Comprehensive and Critical Review. Adv. Mater. 2020, 32, 1905440.
5. Nishihama, S.; Onishi, K.; Yoshizuka, K. Selective Recovery Process of Lithium from Seawater Using Integrated Ion Exchange Methods. Solvent Extr. Ion Exch. 2011, 29, 421-431.
6. Chitrakar, R.; Kanoh, H.; Miyai, Y.; Ooi, K. Recovery of Lithium from Seawater Using Manganese Oxide Adsorbent (H_{1.6}Mn_{1.6}O₄) Derived from Li_{1.6}Mn_{1.6}O₄. Ind. Eng. Chem. Res. 2001, 40, 2054-2058.
7. Zhang, Y.; Sun, W.; Xu, R.; Wang, L.; Tang, H. Lithium extraction from water lithium resources through green electrochemical-battery approaches: A comprehensive review. J. Cleaner Prod. 2021, 285, 124905.
8. Kim. J.-S.; Lee, Y.-H.; Choi, S.; Shin, J.; Dinh, H.-C.; Choi, J. W. An Electrochemical Cell for Selective Lithium Capture from Seawater. Environ. Sci. Technol. 2015, 49, 9415-9422.
9. Kanoh, H.; Ooi, K.; Miyai, Y.; Katoh, S. Electrochemical Recovery of Lithium Ions in the Aqueous Phase. Sep. Sci. Technol. 1993, 28, 643-651.
10. Yu, J.; Fang, D.; Zhang, H.; Leong, Z. Y.; Zhang, J.; Li, X.; Yang, H. Y. Ocean Mining: A Fluidic Electrochemical Route for Lithium Extraction from Seawater. ACS Mater. Lett. 2020, 2, 1662-1668.
11. Bartsch, R. A.; Czech, B. P.; Kang, S. I.; Stewart, L. E.; Walkowiak, W.; Charewicz, W. A.; Heo, G. S.; Son, B. High lithium selectivity in competitive alkali metal solvent extraction by lipophilic crown carboxylic acids. J. Am. Chem. Soc. 1985, 107, 4997-4998.
12. Ohta. K.; Goto, T.; Yamazaki, H.; Pichierri, F.; Endo, Y. Facile and Efficient Synthesis of C-Hydroxycarboranes and C,C′-Dihydroxycarboranes. Inorg. Chem. 2007, 46, 3966-3970.
13. Kitazawa, S.; Kimura, K.; Yano, H.; Shono, T. Lipophilic crown-4 derivatives as lithium ionophores. J. Am. Chem. Soc. 1984, 106, 6978-6983.
14. Grimes, R. N., Carboranes. 3rd ed.; Elsevier Inc.: San Diego. USA, 2016.
15. Keener, M.; Mattejat, M.; Zheng, S.-L.; Wu, G.; Hayton, T. W.; Menard, G. Selective electrochemical capture and release of uranyl from aqueous alkali, lanthanide, and actinide mixtures using redox-switchable carboranes. Chem. Sci. 2022, 13, 3369-3374.
16. Plešek, J.; Janousek, Z.; Heřmánek, S.; Smith, H. D., Direct sulfhydrylation of boranes and heteroboranes, 1,2-dicarba-closo-dodecaborane(12)-9-thiol, 9-HS-1,2-C₂B₁₀H₁₁. In Inorganic Syntheses, Holt, S. L., Ed. Wiley & Sons: New York, 1983; Vol. 22, pp 241-243.
17. Plešek, J.; Janousek, Z.; Heřmánek, S. Synthesis and properties of some icosahedral carborane B,B′-dithiols. Collect. Czech. Chem. Commun. 1980, 45, 1775-1779.
18. Bayer, M. J.; Herzog, A.; Diaz, M.; Harakas, G. A.; Lee, H.; Knobler, C. B.; Hawthorne, M. F. The Synthesis of Carboracycles Derived from B,B′-Bis(aryl) Derivatives of Icosahedral ortho-Carborane. Chem. Eur. J. 2003, 9, 2732-2744.
19. Protection for the Thiol Group. In Greene's Protective Groups in Organic Synthesis, 5th ed.; Wuts., P. G. M., Ed. John Wiley & Sons, Inc.: 2014; pp 837-894.
20. Langecker, J.; Fejfarová, K.; Dušek, M.; Rentsch, D.; Baše, T. Carbon-substituted 9,12-dimercapto-1,2-dicarba-closo-dodecaboranes via a 9,12-bis(methoxy-methylthio)-1,2-dicarba-closo-dodecaborane precursor. Polyhedron 2012, 45, 144-151.
21. Oleshkevich, E. V.; Rys, E. G.; Bashilov, V. V.; Petrovskii, P. V.; Ol'shevskaya, V. A.; Moiseev, S. K.; Ponomaryov, A. B.; Kalinin, V. N. Synthesis and ³¹P NMR study of chromium, molybdenum, and palladium complexes with 9-substituted 1,2-bis(diphenylphosphanyl)-o-carboranes. Russ. J. Gen. Chem. 2017, 87, 2589-2595.
22. Frank. R.; Boehnke, S.; Aliev, A.; Hey-Hawkins, E. From ortho-carbaborane-9-thiol towards new building blocks. Polyhedron 2012, 39, 9-13.
23. Hohman, J. N.; Zhang, P.; Morin, E. I.; Han, P.; Kim, M.; Kurland, A. R.; McClanahan, P. D.; Balema, V. P.; Weiss, P. S. Self-Assembly of Carboranethiol Isomers on Au{111}: Intermolecular Interactions Determined by Molecular Dipole Orientations. ACS Nano 2009, 3, 527-536.
24. Chidsey, C. E. D.; Bertozzi, C. R.; Putvinski, T. M.; Mujsce, A. M. Coadsorption of ferrocene-terminated and unsubstituted alkanethiols on gold: electroactive self-assembled monolayers. J Am. Chem. Soc. 1990, 112, 4301-4306.
25. Uosaki, K.; Sato, Y.; Kita, H. Electrochemical characteristics of a gold electrode modified with a self-assembled monolayer of ferrocenylalkanethiols. Langmuir 1991, 7, 1510-1514.
26. Janek, R. P.; Fawcett. W. R.; Ulman, A. Impedance Spectroscopy of Self-Assembled Monolayers on Au(111): Sodium Ferrocyanide Charge Transfer at Modified Electrodes. Langmuir 1998, 14, 3011-3018.
27. Thomas, J. C.; Goronzy, D. P.; Serino, A. C.; Auluck, H. S.; Irving, O. R.; Jimenez-Izal, E.; Deirmenjian, J. M.; Macháček, J.; Sautet, P.; Alexandrova, A. N.; Baše, T.; Weiss, P. S. Acid-Base Control of Valency within Carboranedithiol Self-Assembled Monolayers: Molecules Do the Can-Can. ACS Nano 2018, 12, 2211-2221.
28. Vericat, C.; Vela, M. E., Benitez, G., Carro, P.; Salvarezza, R. C. Self-assembled monolayers of thiols and dithiols on gold: new challenges for a well-known system. Chem. Soc. Rev. 2010, 39, 1805-1834.
29. Leites, L. A. Vibrational spectroscopy of carboranes and parent boranes and its capabilities in carborane chemistry. Chem. Rev. 1992, 92, 279-323.
30. Thomas, J. C.; Boldog, I.; Auluck, H. S.; Bereciartua, P. J.; Dušek, M.; Macháčk, J.; Bastl, Z.; Weiss, P. S.; Baše, T. Self-Assembled p-Carborane Analogue of p-Mercaptobenzoic Acid on Au{111}. Chem. Mater. 2015, 27, 5425-5435.
31. Sumi, T.; Uosaki, K. Electrochemical Oxidative Formation and Reductive Desorption of a Self-Assembled Monolayer of Decanethiol on a Au(111) Surface in KOH Ethanol Solution. J. Phys. Chem. B. 2004, 108, 6422-6428.
32. Schoenfisch, M. H.; Pemberton, J. E. Air Stability of Alkanethiol Self-Assembled Monolayers on Silver and Gold Surfaces. J. Am. Chem. Soc. 1998, 120, 4502-4513.
33. Zhu, L.; Lv, W.; Liu, S.; Yan, H.; Zhao, Q.; Huang, W. Carborane enhanced two-photon absorption of tribranched fluorophores for fluorescence microscopy imaging. Chem. Commun. 2013, 49, 10638-10640.
34. Kabytaev, K. Z.; Safronov. A. V.; Jalisatgi, S. S.; Hawthorne, M. F. Synthesis and reactions of B-vinylcarboranes. J Organomet. Chem. 2014, 749, 106-108.
35. Dziedzic, R. M.; Spokoyny, A. M. Metal-catalyzed cross-coupling chemistry with polyhedral boranes. Chem. Commun. 2019, 55, 430-442.
36. Zhang, Y.; Tamijani, A. A.; Taylor, M. E.; Zhi, B.; Haynes, C. L., Mason, S. E.; Hamers, R. J. Molecular Surface Functionalization of Carbon Materials via Radical-Induced Grafting of Terminal Alkenes. J. Am. Chem. Soc. 2019, 141, 8277-8288.
37. Ke, X. Prahl, J. M.; Alexander, J. I. D.; Wainright, J. S.; Zawodzinski, T. A.; Savinell, R. F. Rechargeable redox flow batteries: flow fields, stacks and design considerations. Chem. Soc. Rev. 2018, 47, 8721-8743. Compton, R. G.; Banks, C. E., Understanding Voltammetry. 2nd ed.; Imperial College Press
38. Heying, T. L.; Ager, J. W.; Clark, S. L.; Mangold, D. J.; Goldstein, H. L.; Hillman, M.; Polak, R. J.; Szymanski, J. W. A New Series of Organoboranes. I. Carboranes from the Reaction of Decaborane with Acetylenic Compounds. Inorg. Chem. 1963, 2, 1089-1092.
39. Fisher, S. P.; Tomich, A. W.; Lovera, S. O.; Kleinsasser, J. F.; Guo, J.; Asay, M. J.; Nelson, H. M.; Lavallo, V. Nonclassical Applications of closo-Carborane Anions: From Main Group Chemistry and Catalysis to Energy Storage. Chem. Rev. 2019, 119, 8262-8290.
40. Núñez, R.; Tarrés, M.; Ferrer-Ugalde, A.; de Biani, F. F.; Teixidor, F. Electrochemistry and Photoluminescence of Icosahedral Carboranes, Boranes, Metallacarboranes, and Their Derivatives. Chem. Rev. 2016, 116, 14307-14378.
41. Grimes, R. N., Carboranes. 3rd ed.; Elsevier Inc.: San Diego, USA, 2016.
42. Keener, M.; Hunt, C.; Carroll, T. G.; Kampel. V.; Dobrovetsky, R.; Hayton, T. W.; Ménard, G. Redox-switchable carboranes for uranium capture and release. Nature 2020, 577, 652-655.

### CONCLUSION

This concludes the description of the preferred embodiment of the present invention. The foregoing description of one or more embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

1. A composition of matter useful for capturing lithium ions, comprising:
a carborane compound bonded to one or more donor groups, wherein:
the carborane compound comprises a structure that can be modulated electrochemically via application of a current, the current activating a redox reaction switching the structure between a closed state and a an open state,
the switching comprises a rupture of a C—C bond resulting in opening of the structure from the closed state to the open state; and
the donor groups comprise a moiety:
for capturing one or more lithium ions from a liquid in contact with the donor groups in the open state and releasing the lithium ions in the closed state, or
for capturing the one or more lithium ions from the liquid in contact with the donor groups in the closed state and releasing the lithium ions in the open state.

2. The composition of matter of claim 1, further comprising an anchoring group for anchoring to an electrode.

3. (canceled)

4. The composition of matter of claim 1, wherein the one or more donor groups comprise a crown ether.

5. The composition of matter of claim 1, wherein the one or more donor groups comprise an acyclic group.

6. The composition of matter of claim 1, wherein the one or more donor groups comprise Li⁺ binding ligands or Li⁺-selective donor groups.

7. The composition of matter of claim 1, wherein the carborane compound is:
mono-carborane 14-crown-4 that can be reduced to its open state (nido-form 1-nido) using the electrochemical reaction, or
bis-carborane 14-crown-4 (2) that can be reduced to its open state (nido- form, 2-nido) using the electrochemical reaction.

8. The composition of matter of claim 1, wherein the donor compounds comprise a ring and the redox reaction rupturing the C—C bond expands the size of the ring to match or mismatch to a coordinate bond length suitable for bonding to the lithium ion.

9. (canceled)

10. The composition of matter of claim 1, wherein the carborane compound and the donor groups are configured to selectively bind to the lithium ions over Na⁺ and K⁺.

11. The composition of matter of claim 1, wherein:
the carborane compound in the open state comprises carbanions and the carborane compound further comprises one or more electron withdrawing groups bonded to the carborane compound, and
the electron withdrawing groups suppress oxidation of the carbanions in water or air.

12. The composition of matter of claim 1, further comprising a stabilizing compound comprising phosphine oxide bonded to the carborane compound.

13. The composition of matter of claim 1, wherein:
(a) in the closed state, a separation between the donor groups and the lithium ion is mis-matched to a coordinate bond length for binding the donor group to the lithium ion, and in the open state, the separation is matched to the coordinate bond length, or
(b) in the open state, the separation is mismatched to the coordinate bond length and in the closed state the separation is matched to the coordinate bond length.

14. The composition of matter of claim 1, wherein the carborane in the open state comprises carbanions.

15. An apparatus for capturing lithium ions from
a liquid comprising the composition of matter of claim 1, comprising:
a circuit comprising an electrode;
a plurality of compounds each comprising the carborane and one or more donor groups bonded to the carborane, wherein each of the carboranes:
are attached to the electrode, and
have a first state and a second state; and
wherein the circuit is configured to:
apply a current to the electrode in contact with the liquid to switch from the first state to the second state; and
reverse a polarity of the current to switch from the second state to the first state so that:
in the first state the one or more donor groups bind to one or more lithium ions in the liquid and in the second state the one or more donor groups release the one or more lithium ions.

16. (canceled)

17. The apparatus of claim 15, wherein:
the circuit is configured to set the polarity of the current to modulate a redox reaction switching the carborane between the first state and the second state,
the one or more donor groups bind to the lithium ions when the carborane is in the first state associated with a C—C bond in the carborane formed by the current having a first polarity, and
release the lithium ions when the carborane is in the second state associated with the C—C bond in the carborane ruptured in response to the current having the second polarity opposite the first polarity.

18. The apparatus of claim 15, wherein:
the circuit is configured to set the polarity of the current modulating a redox reaction switching the carborane between the first state and the second state,
the one or more donor groups release the lithium ions when the carborane is in the first state associated with a C—C bond in the carborane formed by the current having a first polarity, and
bind to the lithium ions when the carborane is in the second state associated with the C—C bond in the carborane ruptured in response to the current having the second polarity opposite the first polarity.

19. The apparatus of claim 15, wherein:
the first state comprises a closed state of the carborane wherein a C—C bond in the carborane is formed,
the second state comprises an open state of the carborane wherein the C—C bond is ruptured, the circuit is configurable to:
set the current modulating binding capability of the donor groups to the lithium ions by modulating at least one of an electronic state or a size of each of the donor groups, and
set the current activating the redox reaction rupturing the C—C bond in the carborane in the first state to form the carborane in the second state comprising two carbanions that enhance binding of the donor groups to the one or more lithium ions, or
the current activating the redox reaction rupturing the C—C bond associated with the closed state, to expand the donor compounds and form the open state, wherein the donor compounds in the closed state have a size or separation from the lithium ions better matched for stronger binding to the lithium ions as compared to when the carborane is in the open state.

20. The apparatus of claim 15, wherein the liquid comprises a mixture of ions, a Li-rich brine, seawater, underground water, or an organic solution.

21. (canceled)

22. (canceled)

23. (canceled)

24. A composition of matter useful for capturing lithium ions, comprising a compound of the structure:

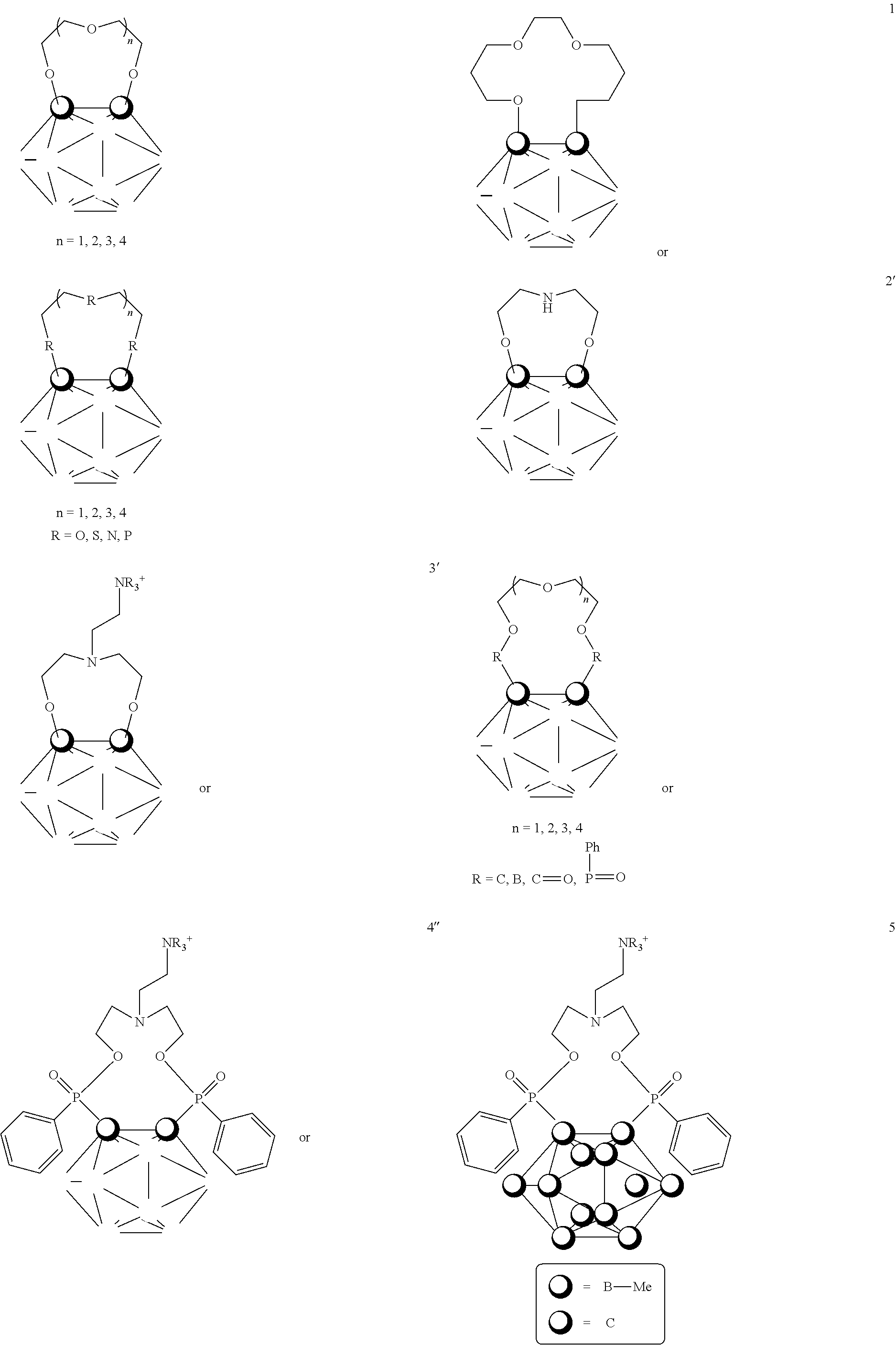

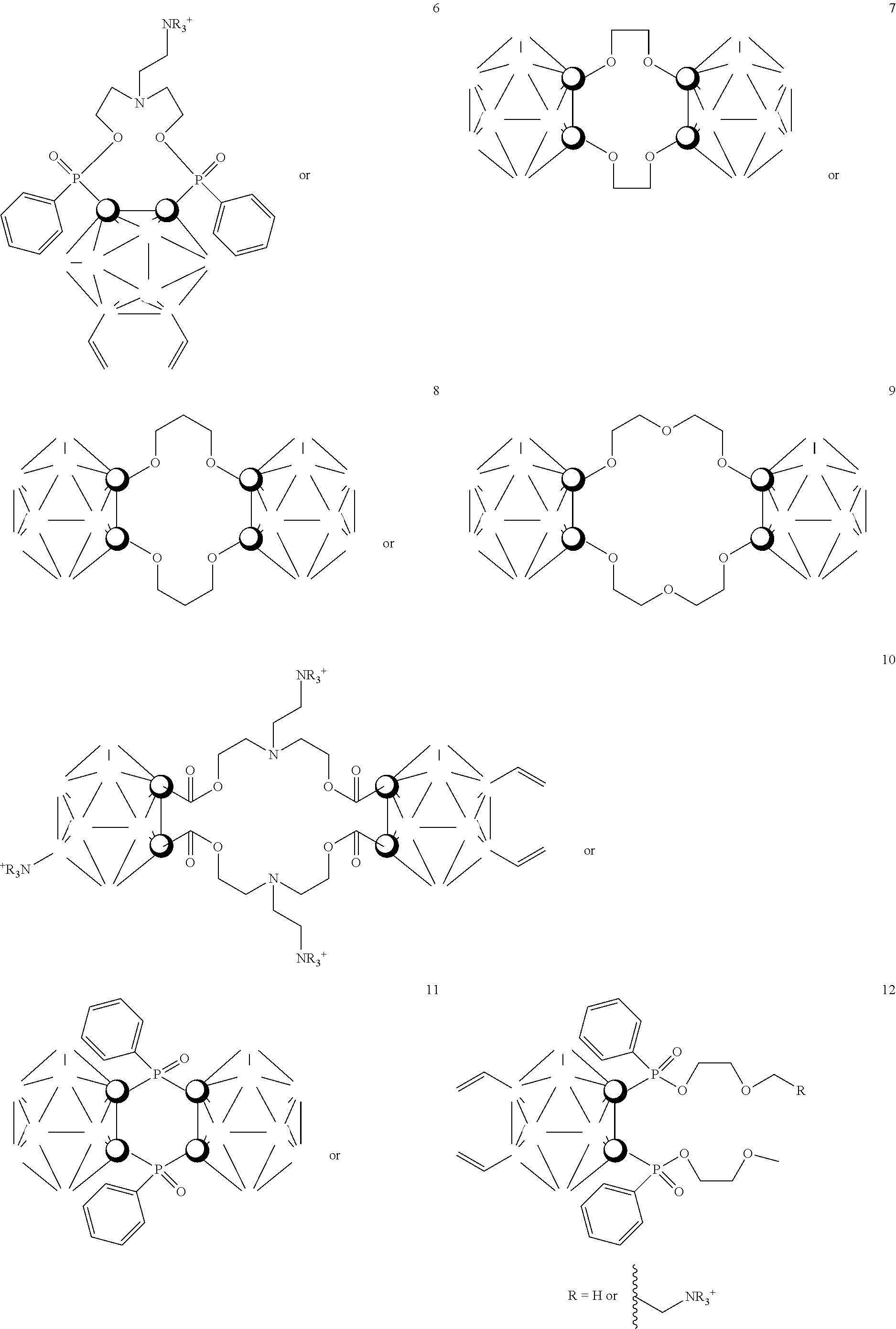

25. (canceled)

26. A composition of matter, comprising:
one or more donor groups each configured to form a coordinate bond with a lithium ion;
means for controlling a separation of the donor groups to the lithium ions, wherein the means is bonded to the donor groups and is configurable to control the separation to match or mis-match with a coordinate bond length associated with formation of the coordinate bond.

27. The composition of matter of claim 26, wherein the means for controlling comprises a carborane having a C—C bond and the carborane can be reversibly switched between a first state when the C—C bond is formed and a second state when the C—C bond is ruptured to form carbanions.
